(19) United States
(12) Patent Application Publication
(10) Pub. No.: US 2010/0104926 A1
(43) Pub. Date: Apr. 29, 2010

(54) DISPERSION OF COMPOSITE MATERIALS, IN PARTICULAR FOR FUEL CELLS

(76) Inventors: Bertrand Baret, Palaiseau (FR); Henri-Christian Perez, Courcouronnes (FR); Pierre-Henri Aubert, Menucourt (FR)

Correspondence Address: MCKENNA LONG & ALDRIDGE LLP, 1900 K STREET, NW, WASHINGTON, DC, 20006, US

(21) Appl. No.: 12/452,219

(22) PCT Filed: Jun. 25, 2008
(86) PCT No.: PCT/FR2008/051165

§ 371 Date: Dec. 22, 2009

(30) Foreign Application Priority Data
Jun. 26, 2007 (FR) 07 04569

(51) Int. Cl. H01M 4/00; H01M 4/88; B01J 21/18

(52) U.S. Cl. 429/44; 502/101; 502/185; 977/742; 977/932; 977/890

(57) ABSTRACT

The invention relates to the preparation of a catalytic composition that comprises a carbonated structuring material (MSC) associated with a catalyst (CAT). The invention comprises mixing a solution of a first solvent (SOL1) including the carbonated structuring material (MSC) and a solution of a second solvent (SOL2) including the catalyst (CAT), and agitating (AGM) the resulting mixture up to the precipitation if the catalyst on the carbonated structuring material. According to one aspect, the catalyst and the structuring material are not soluble in the mixture of the first and second solvents. The composition thus obtained can be used after filtration as a material for an electrode in a fuel cell.

### TECHNICAL FIELD

The present invention relates to the field of fuel cells and more precisely to the active elements of these cells, and also to their method of preparation. It relates in particular to a method for preparing a composite material comprising a carbonated structuring material combined with a catalyst, the materials which can be obtained by this method, and their applications in fuel cells.

### PRIOR ART

Two types of method are generally employed to prepare composite materials for fuel cells. The distinction between these methods is based on the method for dispersing the carbonated element.

When the carbonated element is deposited on a support, various methods are used to introduce the catalytic element. The support, if conducting, can serve as an electrode and the metal nanoparticles can be formed by electrochemical reduction of a catalyst precursor.

The support provided with the carbonated element can also be used for depositing the catalyst by chemical vapor deposition (CVD) or by vacuum evaporation, or even by cathode sputtering.
Dispersion in Liquid Medium

When the carbonated element is dispersed in liquid medium, the catalytic element can be introduced in various ways. The most common way is to place the nanostructured carbon dispersed in liquid medium in contact with a solution of a precursor of the metal nanoparticles. This is followed by chemical treatment (reduction) to form the catalytic element (technique described in particular in the publication of Carmo et al in J. Power Sources 142: 169-176 (2005)).

Another, less widely used, method consists in introducing the preformed catalytic element (in the form of nanoparticles) into the same solvent as the one in which the carbonated element is dispersed. One example of this approach is reported in the publication L., W. Wu et al., Langmuir 20: 6019-6025 (2004). It is proposed to combine gold nanoparticles coated with thiol molecules carrying carboxylic functions with carbon nanotubes. The method involves treating the carbon nanotubes in nitric acid in order to form carboxylic functions on their surface, which allow the interaction with the nanoparticles. In the experiments described, the carbon nanotubes thus pretreated are dispersed in hexane and the nanoparticles are then dissolved in the same medium.

A second example of the use of preformed catalyst nanoparticles is described in the publication by Mu et al J. Phys. Chem. B 109: 22212-22216 (2005). Carbon nanotubes “used as received” are dispersed in toluene and platinum nanoparticles carry triphenylphosphine molecules on the surface. The document stresses the importance of the solubility of the nanoparticles in the same solvent as the one in which the nanotubes are dispersed (toluene). It is also stated that the aromatic rings of the molecule coating the nanoparticles play a unique role in the production of the composite. The document further describes a test on the catalytic activity of the composites with regard to the oxidation of methanol. These cyclic voltammetry tests are preceded by a heat treatment which removes the organic coating from the nanoparticles present on the carbon nanotubes, and causes a partial aggregation of the nanoparticles and an increase in their average size. The mass proportions of the carbon nanotubes to the platinum nanoparticles are at least 3.1%.

Once the carbonated elements/catalytic element composites are prepared, they can be used in various ways in order to be tested for catalytic activity, either by electrochemical tests, by cyclic voltammetry, or by tests in a fuel cell. If the composites have been prepared from carbonated elements dispersed in a liquid medium, it is conventionally possible to prepare an ink from this dispersion after adding an amphiphilic polymer such as Nafion® for example.

Some methods make use of filtration, in particular those using carbon nanotubes as the carbonated element. Document WO 2006/099593 describes the production of “carbon nanotubes/catalyst” composites followed by their filtration on a nylon filter to form a deposit of the composite in which the nanotubes are at least partially oriented. The deposit on the filter is then hot pressed with a second electrode and a Nafion® membrane. The nylon filter is then removed from the assembly. In these membrane/electrode assemblies, the minimum platinum load is 0.1 mg of platinum per cm².

Another example of this type of approach is described in document US-2004/0197638. The composite is prepared by impregnation followed by reduction of a precursor of platinum based catalysts, on the carbon nanotubes, the precursor being dispersed in solution. The whole is then filtered and assembled with a Nafion® membrane. The minimum platinum density of an electrode thus prepared is 3.4 μg/cm².
Drawbacks of the Prior Art

During these combinations, it is necessary to know the quantity of catalysts introduced and to ensure that it is as low as possible, with equivalent cell performance. The lowest platinum density mentioned in the prior art on an electrode appears to be 3.5 μg/cm² according to document US 2004/0197638. In this case, the method used employs a washing step where an unreacted platinum precursor is mentioned, and a step of transfer of the composite to the membrane of a fuel cell of which the platinum yield cannot be maximal.

In fact, since platinum is a precious metal, whose cost accounts for a large share of the total production cost of a cell, it must be used in the smallest possible quantities while preserving (or even improving) the performance of the cell.

Furthermore, the platinum deposition yields on carbon supports must be as close to 1 as possible. This is not the case in the prior art: the yields are not optimal in particular during:

the synthesis of the composite, on the one hand,

and the fixation of the composite to the cell electrode, on the other hand.

The present invention improves the situation.

### SUMMARY OF THE INVENTION

The present invention first relates to a method for preparing a catalytic composition comprising a carbonated structuring material combined with a catalyst.

The inventive method comprises the following steps:

preparing a mixture of a solution of a first solvent comprising a carbonated structuring material and a solution of a second solvent comprising the catalyst, and

stirring the resulting mixture until the catalyst precipitates on the carbonated structuring material.

In particular, the catalyst and the structuring material are insoluble in the mixture of the first and second solvents.

Thus, the inventive method is suitable for preparing a catalytic composition from a dispersion of a carbonated structuring material in a first solvent and the addition of a solution of a second solvent comprising the catalyst, said catalyst being insoluble at least in the final resulting mixture. It is obviously desirable for the structuring material to be insoluble in the mixture of solvents.

This is an original method to the knowledge of the inventors, effective for combining the catalytic element with a carbonated element for the production of electrodes usable in fuel cells and/or for other conventional electrochemical applications.
Definitions

The term “catalytic composition” in the above definition must not be considered in a narrow sense. In fact, each of the elements of the composition does not necessarily have catalytic activity. This is a property of the composition as a whole. In general, the Composition increases the rate of one or more chemical reactions without altering the total change in standard Gibbs energy of the chemical reaction(s). Ideally, such a composition should indefinitely preserve its properties. However, it is recognized in the field that such an objective is inconceivable in practice and that the activity of these compositions decreases with time, in particular because of outdoor pollution. The specificity and activity of the compositions for and with regard to certain reactions is based on the type of catalyst employed.

Furthermore, in the context of the present invention, a “carbonated structuring material” corresponds in particular to the materials typically employed in fuel cells. Such a material is said to be structuring in the sense that the catalyst is deposited thereon. Such a material is generally in the form of a set of particles. It is advantageous for the smallest dimension of the particles to be between 5 nm and 10 μm, and for their largest dimension to be not more than 5 mm and generally equal to or higher than 1 μm.

Among the various morphologies of carbonated structuring materials, a selection can be made in particular from carbon nanotubes, carbon blacks, acetylene blacks, lampblack, or carbon fibers obtained from synthetic yarns or fabrics by carbonization of a polymer, or even a mixture of at least two of these morphologies. For example, a mixture of fibers and nanotubes may have the advantage of a dual porosity. Carbon nanotubes are preferred, typically obtained by pyrolysis and in particular by the method described in document WO 2004/000727.

According to a particular embodiment of the invention, the material may be in the form of a set of particles having multiple morphologies, and in particular dual, such as a mixture of nanotubes and fibers. Such a material generally comprises a proportion of between 1 to 1000 and 1 to 1 of nanotubes, and advantageously between 1 to 1000 and 1 to 10.

A “catalyst”, in the context of the present invention, typically corresponds to redox catalysts, and particularly to those employed in fuel cells and in oxygen reduction. These are generally solid compounds consisting of inorganic particles, such as particles of metal or metal oxides, or particles consisting of the combination of such particles with organic compounds, in particular to form organometallic particles consisting of an inorganic core and an organic crown.

In general, the size of the catalyst particles selected is lower than that of the particles of structuring material, so that the particles of structuring material are advantageously larger than the catalyst particles in at least one of their dimensions, for example the length. Typically, these are nanometer-sized catalyst particles. Preferably, the largest dimension of the catalyst particles does not exceed about 20% of the smallest dimension of the carbonated structural material.

The metal is often selected from noble metals and alloys thereof, and more particularly platinoids and platinoid alloys. Platinoids correspond to the family of platinum, iridium, palladium, ruthenium and osmium. In a nonlimiting manner, platinum is nevertheless preferred in this family. Platinoid alloys comprise at least one platinoid. It may be a natural alloy such as osmiridium (osmium and iridium) or an artificial alloy such as an alloy of platinum and iron, platinum and cobalt, or even platinum and nickel.

The organic molecules in the combination forming the catalyst are advantageously selected in order to complex the surface of the inorganic particles. The complexation carried out can be strong or weak. It is thereby possible to employ organic molecules which are bonded weakly or strongly to the inorganic particles by covalent or ionic bonds.

In a nonlimiting manner, the catalyst may thus consist of metal particles (and preferably nanoparticles) with an organic coating. They may for example be the particles described in document WO 2005/021154.

It is obviously possible to employ a plurality of catalysts in the composition.

For a more detailed summary of catalysts employable in the context of the invention, it will be useful to refer to the examples presented in detail below.

One condition concerning the solvents is that the catalyst is insoluble in the final mixture of the two solvents.

In an embodiment described below, the catalyst is even already insoluble in the first solvent of the carbonated structuring material.

Thus, in the following discussion, the “first solvent” corresponds to a solvent in which the catalyst is insoluble. Solubility is defined as the analytical composition of a saturated solution as a function of the proportion of a given solute in a given solvent. It may in particular be expressed in molarity. A solution containing a given concentration of compound is considered to be saturated if the concentration is equal to the solubility of the compound in the solvent. Thus, solubility can be finite or infinite and, in the latter case, the compound is soluble in all proportions in the solvent concerned.

Typically, a species is considered to be insoluble in a solvent if its solubility is lower than or equal to 10⁻⁹ mol/L.

In order to estimate the solubility of the catalyst in a given solvent, it is possible to measure the concentration of solutions of particles by UV-visible spectrometry, or to observe their precipitation by the naked eye.

Tests with isopropanol as “first solvent” yielded satisfactory results. In general, the family of hydroxylated solvents can be used, which includes isopropanol, as well as methanol, ethanol, a glycol such as ethylene glycol, or a mixture of these solvents can be used.

The “second solvent” can be selected to be identical to or different from the first solvent. If it is different from the first solvent, the mixture of solvents, in the proportions employed, nevertheless leads to a mixture in which the catalyst is insoluble. However, in a preferred but nonlimiting embodiment, the first and second solvents are different.

Most of the solvents which can be used as “second solvent” are in particular organic solvents, such as dimethylsulfoxide, dichloromethane, chloroform and/or a mixture of these solvents.

However, it should be noted that water can be employed as a first and/or second solvent. In general, pairs of solvents (“first” and “second” solvents) can advantageously be defined for a catalyst nanoparticle having a given coating. For example, some nanoparticles are insoluble in water in basic medium, and precipitate when the medium becomes acidic. In the context of the invention, it is therefore possible to disperse the structuring material in water of which the pH is adjusted to be acidic, while the nanoparticles are added to water in a basic medium. Obviously, the pH of the solvents is selected so that the mixture of the two media leads to a pH at which the nanoparticles are insoluble. Thus, using a dispersion of structuring material in basic medium, it is possible to solubilize the catalyst in this dispersion and produce a controlled combination by progressively acidifying the pH of the mixture.

Approximate Exemplary Proportions

The concentration of carbonated structuring material and catalyst may depend on the intended application. In general the concentration of carbonated structuring material in the first solvent is typically between 1 mg/L and 10 g/L. It is preferably lower than 100 mg/L, for example about 20 mg/L.

The catalyst concentration in the second solvent is preferably between 10⁻⁹ mol/L and 10⁻⁴ mol/L, or between 1 mg/L and 10 g/L and preferably between 0.1 g/L and 2 g/L.

The volume of catalyst solution is preferably lower than the volume of the dispersion of carbonated structuring material, in order to promote the precipitation of the nanoparticles on the surface of the carbonated material (in particular when the latter is in the form of nanotubes), the particles preferably remaining insoluble in the first solvent. Typically, the volume ratios are lower than 1 to 5 and preferably about 1 to 25.
Preparation of Solutions and Mixture

The solutions can be prepared in advance. It is advantageous for them to be uniform.

The carbonated structuring material and/or the catalyst are preferably each distributed in its solvent substantially uniformly, so that the respective composition of the solutions are substantially identical throughout their volume. In order to obtain uniform dispersions, it is preferable to subject them to mechanical stirring before recovery. Preferably, the mixture undergoes mechanical stirring, to make the dispersion of carbonated structuring material uniform in its solvent, accelerate the combination of the catalyst with the structuring material, and ultimately promote a uniform distribution of the catalyst on the structuring material.

Thus, the solutions can be obtained by mechanical stirring, and optionally by ultrasonic treatment. In particular, the ultrasonic treatment of a solution comprising the structured material in the form of carbon nanotubes is advantageous, because it serves to separate the aggregates of aligned carbon nanotubes for which a simple stirring would not have been sufficient. Moreover, this treatment has the effect of breaking the nanotubes and reducing their original size. The average size of the nanotubes obtained depends on the duration of the dispersive treatment.

The dispersions can then be homogenized by mechanical stirring.

It should therefore be observed that the carbonated structuring material is advantageously dispersed in its solvent. The resulting solution is called “dispersion” below. Similarly, the resulting solution of the mixture of the dispersion of structuring material and the catalyst solution also corresponds to a dispersion.

According to a first embodiment, the mixture is prepared by adding the dispersion comprising the structuring material to the solution comprising the catalyst.

A second, preferred embodiment rather corresponds to the addition of the solution comprising the catalyst to the dispersion comprising the structuring material, as described in the exemplary embodiments below. The addition can be made directly or drop-by-drop, controlled at a typical rate of 1 mL/min for a concentration of about 5 μg/L to 500 μg/L for example.
Treatment of the Mixture

Advantageously, the mixture of solutions also undergoes a stirring which can be provided by any type of stirrer, such as a magnetic stirrer.

It is recommended to maintain the stirring until the precipitation of the catalyst on the structuring material is substantially complete. In order to confirm whether the precipitation is substantially complete, it is possible to observe the supernatant after having stopped the stirring. The optical absorption of the supernatant is normally intermediate between that of the initial mixture and that of a solution in the absence of catalyst, and it can thus be compared with these respective absorptions. Thus, the precipitation is substantially complete if the absorbance of the supernatant is close to that of a catalyst-free solution, for example at a wavelength in the ultraviolet close to 300 nm.

In practice, the end of the mechanical stirring of the mixture can be decided if the absorbance of the supernatant in the mixture is lower, for example, than 10% of the value of the absorbance of the mixture before stirring. At high initial concentrations, a simple check of the appearance of the supernatant by the naked eye also helps to appreciate the precipitation, in particular by comparison with a catalyst-free solution.
Optional Additions

According to a particular embodiment of the invention, one or more surfactants can be introduced into at least one of the solutions or into the mixture. Surfactants are molecules comprising a lipophilic portion (apolar) and a hydrophilic portion (polar). Among usable surfactants, mention can be made in particular of:

i) anionic surfactants whereof the hydrophilic portion is negatively charged

ii) cationic surfactants whereof the hydrophilic portion is positively charged

iii) zwitterionic surfactants which are neutral compounds having formal electric charges of one unit and opposite sign

iv) amphoteric surfactants which are compounds behaving both as an acid or as a base depending on the medium in which they are placed (these compounds may have a zwitterionic property), such as amino acids

v) neutral (nonionic) surfactants whose surfactant properties, in particular hydrophilic, are provided by uncharged functional groups such as an alcohol, an ether, an ester or even an amide, containing heteroatoms such as nitrogen or oxygen; due to the low hydrophilic concentration of these functions, nonionic surfactant compounds are usually polyfunctional.

In the case of a use of surfactants with fillers, they may obviously contain several fillers, such as for example a long carbonated chain comprising 5 to 22 and preferably 5 to 14 carbon atoms. They may in particular be aliphatic chains.

In a preferred embodiment, at least Nafion® (copolymer of tetrafluoroethylene sulfate having the molecular formula C₇HF₁₃O₅S.C₂F₄) is used as surfactant.
Treatment of the Mixture to Isolate the Composition

According to one of the advantages procured by the invention, which is described in detail below, the mixture thus obtained can preserve its properties, in liquid form, for a few months. However, to subsequently isolate the composition comprising the catalyst combined with the carbonated structure, the method according to the invention may further comprise an additional step of removal of the solvent from the composition.

This removal can be carried out in particular by evaporation. It is recommended to conduct this operation under reduced pressure. For this purpose, it is possible to use a rotary evaporator, for example. The operating conditions typically depend on the type of solvent(s) used in the mixture.

The composite can also be isolated by filtration or by spraying the composition on an advantageous support. It is preferable for the advantageous support to have a high specific surface area. It is generally a porous support and in particular an electrically conducting porous support of fluid diffusion layers such as fabrics, paper, carbon felt or any other support of this type.

Electrodes are thereby obtained having a catalytic activity that can be evaluated in a conventional electrochemical rig in a three-electrode cell (FIG. 1) or in a fuel cell. With reference to FIG. 1, such a rig conventionally comprises:

a reference electrode REF,

a working electrode ELE (for example comprising a sample of the composite obtained by the implementation of the invention),

and a counter-electrode CELE,

immersed in an acidic electrolyte BEL which may include dissolved oxygen.

The catalytic activity of the electrode thus obtained can be improved by chemical or heat treatment to remove an organic crown possibly present on the catalyst particles. These treatments in no way alter the surface distribution of the catalyst on the structuring material.
Other Aspects of the Invention

The invention also relates to compositions and composite materials which can be obtained by the method discussed above. It also relates to an electrode for an electrochemical application, for example an electrode of a fuel cell, comprising a composite material obtained by the inventive method. Typically, an electrode in the context of the invention may comprise a platinum filler which may be relatively light in comparison with the prior art, for example equal to or higher than about 0.1 μg/cm².

It, is possible to obtain identical surface densities of the catalyst on the electrode, but, on the other hand, different volume densities, with the result of being able to adjust the electrochemical behavior of the electrode at will. This is because, on the electrode, the quantity of platinum per unit area can be selected by controlling two parameters:

on the one hand, the total volume of composition in suspension deposited on the support,

on the other hand, the mass proportion of the carbonated element with regard to the catalytic element.

When the catalyst used comprises particles according to the teaching of document WO 2005/021154, the electrodes obtained by implementing the invention are active without the need to carry out any post-treatment. However, the performance in terms of current and redox potential can be further improved by a conventional heat or chemical treatment which in no way alters the size or distribution of the nanoparticles precipitated on the carbonated structuring material.
Improvements Provided by the Invention

The combination of the catalyst with the carbonated material is made with a yield of between 0.8 and 1. This result is obtained by using a solvent for dispersing the carbonated materials, a solvent in which, in the context of the invention, the particles are insoluble.

The platinum/carbon mass proportion (denoted X for the Pt/C ratio) is controlled in a wide range and easily adjustable. The maximum value of this ratio X depends on the specific surface area of the carbonated element. The minimum value may thus be as low as 0.001, as shown in the exemplary embodiments below.

The compositions obtained are stable over time in the liquid medium and can retain their electrochemical activity for a period of several months (typically six months or more).

Electrodes comprising a platinum filler of barely a tenth of a microgram per cm² (for example 0.33 μg/cm²) can be prepared, and their electrochemical activity due to the platinum is nevertheless observable.

The liquid dispersions of composite material are deposited simply by filtration or spraying on a porous support (for example a diffusion layer support of a fuel cell, such as a fabric, paper, or carbon felt), with a typical filtration yield of 90 to 100%.

Electrodes demonstrating catalytic activity have very low carbon nanotube fillers, about ten micrograms per square centimeter.

### LIST OF FIGURES

Other features and advantages of the invention will appear from an examination of the detailed description below, in conjunction with the appended drawings in which:

FIG. 1 shows a conventional “three electrode” electrochemical device, the working electrode ELE being the one containing the composition of the invention,

FIG. 2 schematically shows the steps involved in the preparation of the composition of the invention,

FIG. 3 shows examples of platinum nanoparticles comprising an organic coating,

FIG. 4 is a TEM image of a composite of Pt-1 platinum nanoparticles/carbon nanotubes,

FIG. 5 is a TEM image of a composite of Pt-2 platinum nanoparticles/carbon nanotubes in a mass proportion of 4/5, intended to be filtered subsequently to form an electrode having a theoretical maximum content of pure platinum of 56 μg/cm²,

FIG. 6a is a SEM image of the composite of FIG. 4, after filtration,

FIG. 6b is an EDX diagram of the composition observed by SEM in FIG. 6a,

FIG. 7 is a TEM image of a composite of Pt-1 platinum nanoparticles/carbon nanotubes, in a mass proportion of 2/3, intended to be subsequently filtered to form an electrode having a theoretical maximum content of pure platinum of 58 μg/cm²,

FIG. 8 is a TEM image of a composite of Pt-1 platinum nanoparticles/carbon nanotubes, in a mass proportion of 1/1, intended to be subsequently filtered to form an electrode having a theoretical maximum content of pure platinum of 58 μg/cm²,

FIG. 9 is a TEM image of a composite of Pt-1 platinum nanoparticles/carbon nanotubes, in a mass proportion of 3/2, intended to be subsequently filtered to form an electrode having a theoretical maximum content of pure platinum of 85 μg/cm²,

FIGS. 10a and 10b are TEM images of a composite of Pt-1 platinum nanoparticles/carbon nanotubes, in a mass proportion of 2/5, intended to be subsequently filtered to form an electrode having a theoretical maximum content of pure platinum of 29 μg/cm²,

FIG. 11 is a TEM image of a composite of Pt-1 platinum nanoparticles/carbon nanotubes in a mass proportion of 1/1 at a larger scale by the use of an ultrasonic tank, intended to be subsequently filtered to form an electrode having a theoretical maximum content of pure platinum of 67 μg/cm²,

FIG. 12 is a TEM image of a composite of Pt-1 platinum nanoparticles/carbon nanotubes in a mass proportion of 1/1 at a larger scale by the use of an ultrasonic tank, intended to be filtered subsequently on a larger apparatus to prepare a larger diameter electrode having a theoretical maximum content of pure platinum of 73 μg/cm²,

FIG. 13 is a TEM image of a composite of Pt-1 platinum nanoparticles/carbon nanotubes in a mass proportion of 1/10 from a solution of nanoparticles containing 50 μg/ml, intended to be filtered subsequently to prepare an electrode having a maximum pure platinum content of 6.7 μg/cm²,

FIGS. 14a and 14b are TEM images of a composite of Pt-1 platinum nanoparticles/carbon nanotubes in mass proportions of 1/50 and 1/100, respectively, from a solution of nanoparticles containing 10 and 5 μg/ml, respectively, the composite being intended to be filtered subsequently to prepare an electrode from the composite in a proportion of 1/100 of which the theoretical maximum pure platinum content is 0.66 μg/cm²,

FIG. 15 is a TEM image of a composite of Pt-0 platinum nanoparticles/carbon nanotubes in a mass proportion of 1/1 from a solution of nanoparticles containing 500 μg/ml, the composite being intended to be filtered subsequently to prepare an electrode having a theoretical maximum content of pure platinum of 66 μg/cm²,

FIG. 16 is a TEM image of a composite of Pt-1 platinum nanoparticles/carbon black in a mass proportion of 5/4 from a solution of nanoparticles containing 500 μg/ml, the composite being intended to be filtered subsequently to prepare an electrode having a theoretical maximum content of pure platinum of 110 μg/cm²,

FIG. 17 compares the voltammogram of the electrochemical response of the reduction of aqueous oxygen for the series in example 7 (solid line) with the voltammogram of the response of the same sample in a solution containing no oxygen (dotted lines),

FIG. 18 compares the voltammograms for the series in example 7 (platinum ratio 1/1—solid line), for the series in example 9 (platinum ratio 1/10—long/short broken lines) and for the series in example 8 (platinum ratio 1/100—dotted lines),

FIG. 19 compares the voltammograms for the series in example 7 without chemical treatment with hydrogen peroxide (solid line), for the same series of example 7 with 20 minutes chemical treatment with 30% hydrogen peroxide (long/short broken lines) and for the same series of example 7 with 30 minutes of chemical treatment with 30% hydrogen peroxide (dotted lines),

FIG. 20 compares the voltammograms for the series of example 7 without heat treatment and for the same series of example 7 with heat treatment of 1 hour at 200° C. under vacuum (dotted lines),

FIG. 21 compares the voltammograms for two equivalent fillers of about 0.65 μg/cm² obtained from 100 μL of dispersion containing 20 mg/L of nanotubes (solid curve), and from 1 mL of dispersion containing 2 mg/L (dotted curves),

FIG. 22 compares the voltammograms for low platinum fillers, with in particular two samples taken from the same series having a platinum density of 0.33 μg/cm² (in dotted lines and long/short broken lines), and with two times more platinum, or a density of 0.65 μg/cm² (solid line),

FIG. 23 is a voltammogram measured with an electrode comprising a composite obtained with carbon black (example 11 described below),

FIG. 24 is a voltammogram measured with an electrode comprising a composite obtained with carbon fibers (example 12 described below),

FIG. 25 is an image obtained by scanning electron microscopy of a composite of Pt-0 nanoparticles on a mixture of carbon fibers and nanotubes in a mass proportion of 1/60, the composite then being intended to be filtered to prepare an electrode having a theoretical pure platinum content of about 9 μg/cm²,

FIG. 26 is a voltammogram showing the electrochemical activity of an electrode prepared according to another exemplary embodiment (example 13a described below) relative to the reduction of oxygen,

FIG. 27 is a voltammogram showing the electrochemical activity of an electrode prepared according to another exemplary embodiment (example 13b described below) relative to the reduction of oxygen,

FIG. 28 is a voltammogram showing the electrochemical activity of an electrode prepared according to another exemplary embodiment (example 13c described below) relative to the reduction of oxygen,

FIG. 29 is a voltammogram showing the electrochemical activity of an electrode prepared according to another exemplary embodiment (example 14 described below) relative to the reduction of oxygen,

FIG. 30 is a voltammogram showing the electrochemical activity of an electrode prepared according to another exemplary embodiment (example 15 described below) relative to the reduction of oxygen,

FIG. 31 is a voltammogram showing the electrochemical activity of an electrode prepared according to another exemplary embodiment (example 16 described below) relative to the reduction of oxygen,

FIG. 32 shows a formula of the Pt-4 particle,

FIG. 33 is a voltammogram showing the electrochemical activity of an electrode prepared according to another exemplary embodiment (example 17 described below) relative to the reduction of oxygen,

FIG. 34 is a voltammogram showing the electrochemical activity of an electrode prepared according to another exemplary embodiment (example 18 described below) relative to the reduction of oxygen,

FIG. 35 is a voltammogram showing the electrochemical activity of an electrode prepared according to another exemplary embodiment (example 19 described below) relative to the reduction of oxygen,

FIG. 36 is a voltammogram showing the electrochemical activity of an electrode prepared according to another exemplary embodiment (example 20 described below) relative to the reduction of oxygen,

FIG. 37 is a voltammogram showing the electrochemical activity of an electrode prepared according to another exemplary embodiment (example 21 described below) relative to the reduction of oxygen,

FIG. 38 is a voltammogram showing the electrochemical activity of an electrode prepared according to another exemplary embodiment (example 22 described below) relative to the reduction of oxygen,

FIG. 39 is a voltammogram showing the electrochemical activity of an electrode prepared according to another exemplary embodiment (example 23 described below) relative to the reduction of oxygen,

FIG. 40 is a voltammogram showing the electrochemical activity of an electrode prepared according to another exemplary embodiment (example 24 described below) relative to the reduction of oxygen,

FIG. 41 is an image taken by optical microscopy of a sample prepared by deposition by spraying from a dispersion according to example 13b containing carbon nanotubes and carbon fibers to which Nafion has been added,

FIG. 42 is a voltammogram showing the electrochemical activity of an electrode prepared according to another exemplary embodiment (example 25 described below) relative to the reduction of oxygen.

### EXEMPLARY EMBODIMENTS AND RESULTS OBTAINED

The catalytic materials used in the exemplary embodiments below are metal nanoparticles, mainly so-called “functionalized” nanoparticles of platinum, whereof the organic coating can be chemically modified and which already have electro-catalytic activity for reducing oxygen, without the need to carry out any chemical or physical preconditioning. Such platinum nanoparticles as catalysts are described in document EP 1663487.

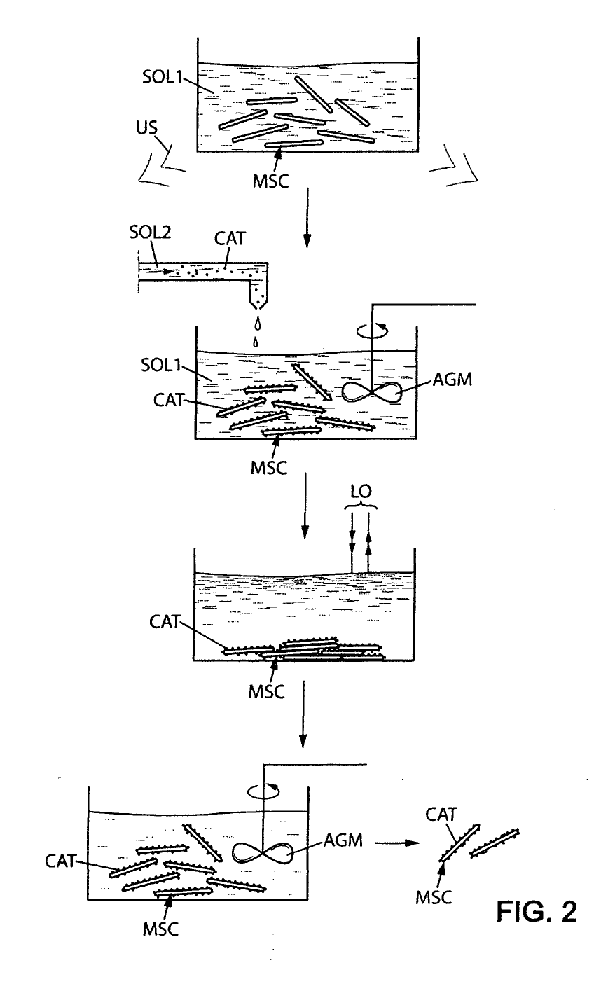

For example, several types of particles are available, of which the representations are given in FIG. 2 and are named Pt-0, Pt-1, Pt-2, Pt-3.

These particles are crystalline and their size is between 2 and 3 nm. They are obtained in the form of powders from which solutions are prepared having concentrations selected for the intended applications (0.5 mg/ml, 0.05 mg/ml, or other). Depending on the organic coating (Pt-0, Pt-1, Pt-2, Pt-3), the solvent used is polar aprotic such as, for example, dimethylsulfoxide, or apolar (dichloromethane, chloroform, or other).

Solutions comprising platinum nanoparticles are brown in color, with a more intense coloring with increasing nanoparticle concentration.

As stated above, the carbonated materials are preferably multiwall carbon nanotubes synthesized in the laboratory by chemical vapor deposition (CVD) of aerosol. This synthesis is suitable for obtaining nanotubes with controlled lengths. They are aligned, hence not tangled, and can therefore be dispersed very easily in liquid medium, for example in isopropanol without additive, under the effect of a treatment by stable ultrasound (using a power probe or simply in a laboratory ultrasonic tank). Before use, the nanotubes may also be heat treated at 2000° C. for about two hours to remove a catalyst residue allowing their synthesis.

The few examples described here concern the combination of nanotubes and nanoparticles. In other examples, however, it is shown that the inventive method can be implemented with standard carbon blacks and/or with carbon fibers having a diameter of about ten microns. Mixtures of compositions based on different carbonated supports can also be used, particularly based on nanotubes on the one hand, and fibers on the other hand.

In most of the examples described below, the following steps are preferably carried out.

A carbonated structuring material is dispersed in a liquid medium by weighing a given quantity of carbonated material that is introduced into a container and to which a given volume of solvent is added. The solvent is selected from solvents in which the catalyst nanoparticles to be added subsequently are not soluble. With reference to FIG. 2, an isopropanol solution SOL1 can typically be used, comprising a carbon nanotube concentration MSC of about 20 mg/liter.

This preparation undergoes ultrasonic treatment US (probe or ultrasonic tank) to separate the aggregates of aligned carbon nanotubes. A simple mechanical stirring to break the nanotubes rapidly and thereby reduce their initial size may not be sufficient. The average size of the nanotubes subsequently obtained depends on the duration of the dispersive treatment. The treatment is generally stopped when the dispersion seen by the naked eye only comprises small aggregates in the form of pellets (no longer aligned and interconnected nanotubes). A surfactant such as Nafion® can then be added as indicated above.

This dispersion is then mixed with a known volume of solution SOL2 of catalyst nanoparticles CAT (coated platinum for example) having a selected concentration. The volume of nanoparticle solution, preferably added drop-by-drop, must preferably be low compared to the volume of nanotube dispersion, in order to promote the precipitation of the nanoparticles on the surface of the nanotubes. Typically, the volume ratios of about 1 to 25 have yielded good results.

The mixture is maintained with mechanical stirring AGM for at least the time required for the nanoparticles to precipitate on the nanotubes. A good means of knowing this time is to make an optical reading LO of the supernatant. As an alternative, it is obviously possible to measure this time for a first preparation and then to apply it systematically to subsequent preparations for similar types of products in the same proportions. In fact, if the type of solvent for dispersing the nanotube SOL1 is changed, the particles can be led to precipitate more or less rapidly. A surfactant can optionally be added subsequently, for example Nafion®.

The composite thus formed (catalyst element/carbonated element) can be preserved for a long time as such (liquid). However, it can be recovered in solid form, particularly by filtration, in which case the mixture is again preferably stirred (AGM) before recovering the composite. Filtration on conductive porous supports is particularly advantageous.

However, it is important to stress that filtration is not the only possible alternative. Other methods, such as simple spraying of the composite dispersion on a support of the abovementioned type, are also feasible as indicated above.

To improve the catalytic activity of the composite material obtained, after preparing the electrodes, a chemical treatment can be provided (by a 30% hydrogen peroxide solution for 20 to 30 minutes), or preferably a heat treatment (at 200° C. under rough vacuum for 1 to 2 hours), in order to remove the organic crown present on the particles. These treatments do not alter the surface distribution of platinum on the carbon.

### Properties and Characterizations of Compositions Obtained

The fact that the nanoparticles/carbonated support combination is effectively due to the precipitation of the nanoparticles in a medium containing a large quantity of solvent in which these nanoparticles are nevertheless insoluble, can be demonstrated in two ways.

On the one hand, it is possible to observe that if the solid composite is recovered and replaced in the presence of the solvent of the nanoparticles, they are again dispersed and are therefore detached from the nanotubes (visible coloring of the solvent after a few moments), thereby demonstrating a real influence of the solvent(s).

On the other hand, by centrifugation of the dispersions, it is found that the supernatant of the dispersions is virtually colorless in comparison with a reference standard only containing nanoparticles in the same mixture of solvents and before precipitation of the particles.

Furthermore, the state of the carbonated element/catalytic element combination can be checked and controlled by Transmission Electron Microscope (TEM) imaging from liquid suspensions or by Scanning Electron Microscope (SEM) after deposition on porous conductive supports.

The catalytic activity of the composites that are filtered or sprayed on a porous conductive element (and optionally then subjected to heat or chemical treatment), can be tested by cyclic voltammetry in medium saturated with oxygen under 1 bar pure oxygen, the electrolyte being perchloric acid in a concentration of 1 mol/L.

As stated above, on the electrode, the quantity of platinum per unit area can be adjusted by controlling two parameters:

on the one hand, the total volume of composite suspension that is deposited on the electrode,

on the other hand, the mass proportion of the carbonated element with regard to the catalytic element.

For a dispersion, these volumes are sampled with mechanical stirring so that the samplings are reproducible and controlled. Determination of the sampled volume serves to determine the quantity of composite deposited and hence the maximum quantity of platinum that the electrode comprises, hence the usefulness of mechanical stirring in the inventive method. This quantity can be checked later by weighing if the deposited mass is measurable (typically higher than 10 μg).

In the examples below, the weighings demonstrated that the deposition yields could reach practically 100%. They were nevertheless lower when the carbonated element was carbon black deposited by filtration.

### EXAMPLE 1

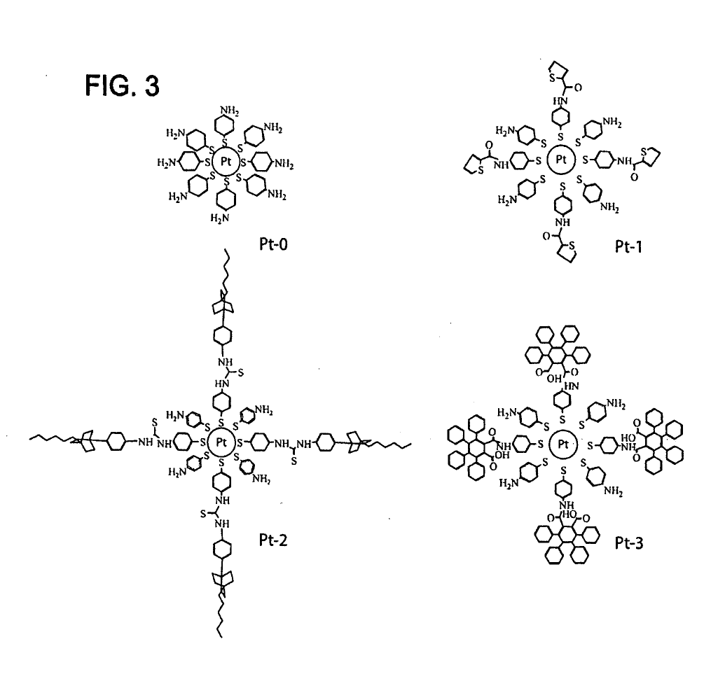

In a 10 mL flask, 2 mg of annealed carbon nanotubes are weighed (as carbonated structuring material) to which 5 mL of isopropanol are added (as “first solvent”). The mixture is treated for two minutes by ultrasound with a Bioblock Vibracell® 75043 probe at 20% of its maximum capacity. 2 mL of solution of Pt-1 nanoparticles are then added drop-by-drop (about 1 mL/min) with stirring, as catalyst (FIG. 3), in a concentration of 418 μg/mL in dimethylsulfoxide or DMSO (as “second solvent”). After addition, the mixture obtained is stirred for four hours. After settling, the supernatant is found to be colorless, indicating that the particles have precipitated. The supernatant is removed and 3 mL of isopropanol are added, as well as 2 mL of 10% Nafion® solution in water.

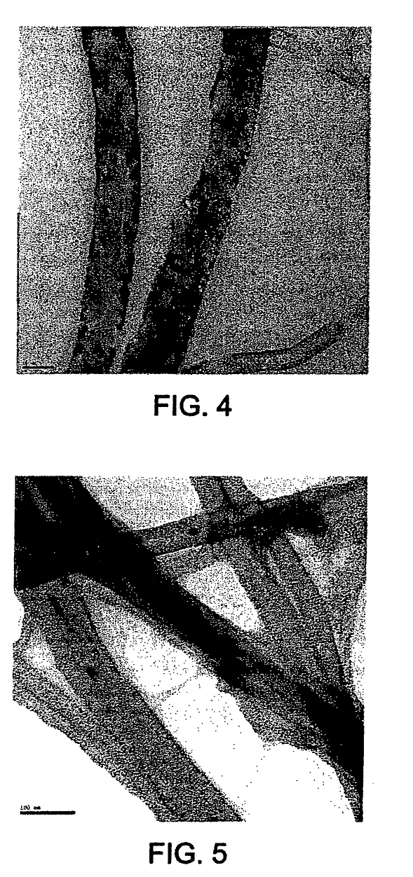

FIG. 4 shows a view of a drop of dispersion observed by TEM. Nanotubes nearly completely covered with platinum nanoparticles are obtained (dark spots in the picture, size about 2 to 3 nm, on the surface of the tubes).

### EXAMPLE 2

In a 100 mL container, 1 mg of nanotubes having an average initial length of 150 μm is introduced. 50 mL of isopropanol are added. Ultrasonic treatment is carried out for 4 minutes using a Bioblock Vibracell® 75043 probe at 30% of its maximum capacity. 2 mL of solution of type Pt-2 nanoparticles (FIG. 3) containing 415 μg/mL in dichloromethane are then added with stirring. After addition, stirring is continued for 24 hours.

FIG. 5 shows a view of a drop of dispersion observed by TEM. The nanotubes are found to be nearly completely covered with nanoparticles.

The filtration of 10 mL of dispersion of the composite obtained (nanotubes/nanoparticles) on a 2.3 cm² carbon felt disk, gives a difference in mass of 0.33 mg, corresponding to a filtration yield of 91% of the mass of platinum. The effective density of platinum nanoparticles (with organic coating) is 63 μg/cm², corresponding to a density of pure platinum (without coating) of about 51 μg/cm².

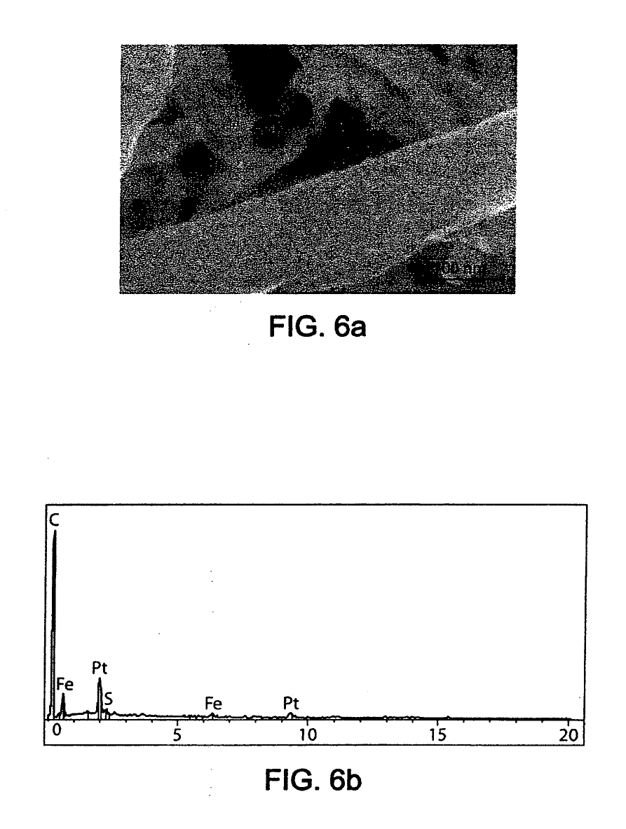

In FIGS. 6a and 6b), an SEM/EDX observation of the deposit on the filter (scanning electron microscope duplicated by energy dispersion X-ray analysis) shows that the distribution of particles on the nanotubes during the filtration is completely undisturbed and that the deposit on the nanotubes clearly remains platinum with a surrounding organic crown (presence of sulfur).

The mass ratio of the nanoparticles and nanotubes introduced is about 4/5.

### EXAMPLE 3

In a 100 mL container, 1.3 mg of nanotubes having an average initial length of 150 μm are introduced with 50 mL of isopropanol. Ultrasonic treatment is carried out for 4 minutes using a Bioblock Vibracell® 75043 probe at 30% of its maximum capacity. 2 mL of solution of type Pt-1 nanoparticles containing 432 μg/mL in DMSO are then added with stirring. Stirring is continued for 24 hours.

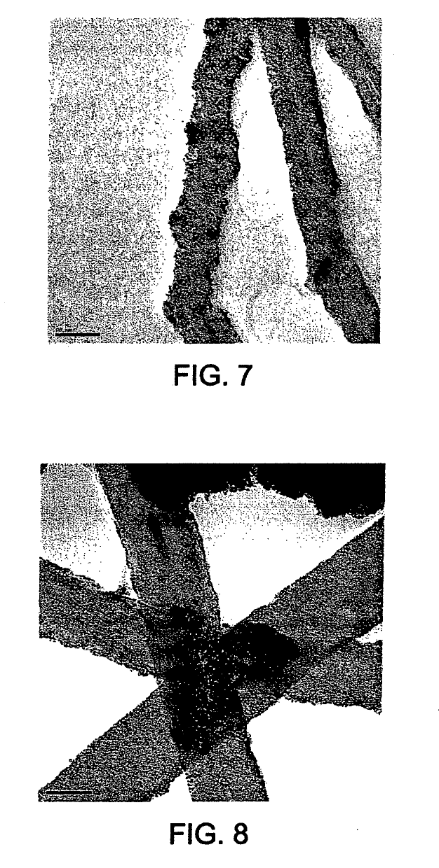

FIG. 7 shows a view of a drop of dispersion observed by TEM. The nanoparticles are clearly observed to be present on the carbon nanotubes.

The filtration of 10 mL of dispersion on a carbon felt disk gives a difference in mass of 0.32 mg, corresponding to 83% of the mass introduced. The mass ratio of nanoparticles and nanotubes introduced is 2/3. The effective density of platinum nanoparticles (with organic coating) is 60 μg/cm², corresponding to a density of pure platinum (without coating) of about 48 μg/cm².

### EXAMPLE 4

In a 100 mL container, 1.0 mg of nanotubes having an average initial length of 150 μm are introduced with 50 mL of isopropanol (20 mg/L). Ultrasonic treatment is carried out for 4 minutes using a Bioblock Vibracell® 75043 probe at 30% of its maximum capacity. 2 mL of solution of type Pt-1 nanoparticles containing 432 μg/mL in DMSO are then added with stirring. Stirring is continued for 24 hours.

FIG. 8 shows a view of a drop of dispersion deposited on a support for observation by TEM.

The filtration of 10 mL of dispersion on a carbon felt disk gives an average difference in mass of 0.33 mg, corresponding to 92% of the mass introduced. The mass ratio of nanoparticles and nanotubes introduced is 1. The effective density of platinum nanoparticles (with organic coating) is 66 μg/cm², corresponding to a density of pure platinum (without coating) of about 53 μg/cm².

### EXAMPLE 5

In a 100 mL container, 1.0 mg of nanotubes having an average initial length of 150 μm are introduced with 50 mL of isopropanol. Ultrasonic treatment is carried out for 4 minutes using a Bioblock Vibracell® 75043 probe at 30% of its maximum capacity. 3 mL of solution of type Pt-1 nanoparticles containing 432 μg/mL in DMSO are then added with stirring. Stirring is continued for 24 hours.

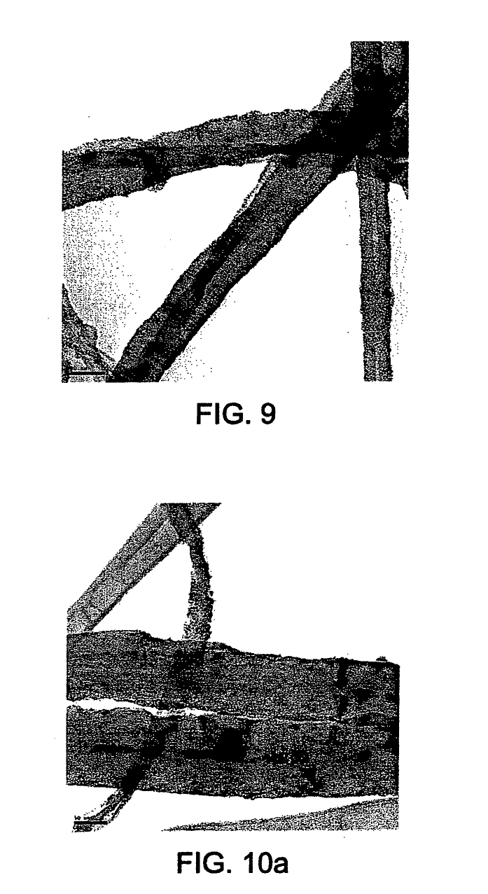

FIG. 9 shows a view of a drop of dispersion observed by TEM. The filtration of 10 mL of dispersion on a carbon felt disk gives a difference in mass of 0.33 mg, corresponding to 86% of the mass introduced. The mass ratio of nanoparticles and nanotubes introduced is 3/2. The effective density of platinum nanoparticles (with organic coating) is 91 μg/cm², corresponding to a density of pure platinum (without coating) of about 73 μg/cm².

### EXAMPLE 6

In a 100 mL container, 1.0 mg of nanotubes having an average initial length of 150 μm are introduced with 50 mL of isopropanol (20 mg/L). Ultrasonic treatment is carried out for 4 minutes using a Bioblock Vibracell® 75043 probe at 30% of its maximum capacity. 1 mL of solution of type Pt-1 nanoparticles containing 432 μg/mL in DMSO is then added with stirring. Stirring is continued for 1 day.

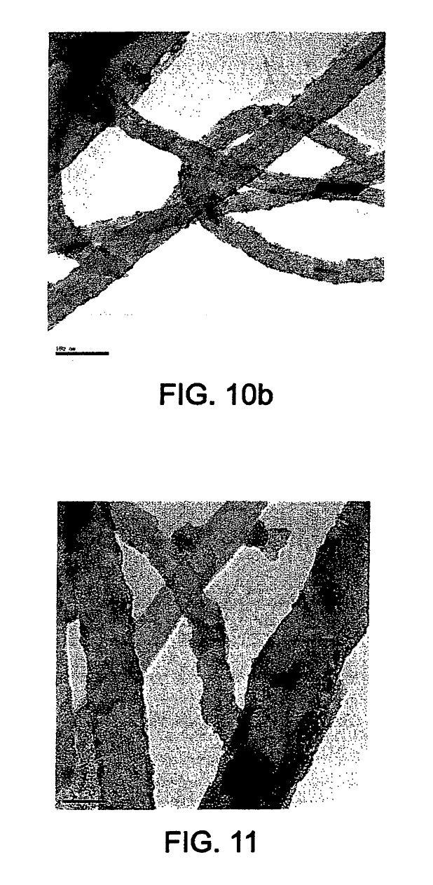

FIGS. 10a and 10b show a view of a drop of dispersion observed by TEM.

The filtration of 10 mL of dispersion on a carbon felt disk gives a difference in mass of 0.21 mg, corresponding to 75% of the mass introduced. The mass ratio of nanoparticles and nanotubes introduced is 2/5 and a lower coverage of the nanotubes than previously can be observed in FIGS. 10a and 10b.

The effective density of nanoparticles is 28 μg/cm², corresponding to a density of pure platinum of about 22 g/cm².

### EXAMPLE 7

It is confirmed here that the change in scale is possible (with larger volumes).

In a 2 L container, 20.1 mg of nanotubes having an average initial length of 150 μm are added with 1 L of isopropanol. An ultrasonic treatment is carried out this time for 3 times 15 minutes in a Transsonic® TI-H 15 ultrasonic tank at 80% of its maximum capacity and a frequency of 25 kHz. 40 mL of solution of platinum Pt-1 containing 500 μg/mL in DMSO are then added drop-by-drop (about 1 mL/min) with stirring. After addition, the stirring is maintained for 3 days.

FIG. 11 shows a view of a drop of composite observed by TEM. The deposition of nanoparticles on the carbon nanotubes is again observed.

The mass ratio of nanoparticles and nanotubes introduced is 1/1. The filtration of 10 mL of dispersion, on a carbon felt disk, gives a difference in mass of 0.35 mg, corresponding to 92% of the mass theoretically introduced. The effective density of nanoparticles is 83 μg/cm², corresponding to a density of pure platinum of about 66 g/cm².

### EXAMPLE 7-bis

In a 1 L flask container, 20.0 mg of nanotubes having an average initial length of 150 μm are added with 1 L of isopropanol. An ultrasonic treatment is carried out this time for 4 hours in a Transsonic® TI-H 15 ultrasonic tank at 90% of its maximum capacity and a frequency of 45 kHz. 40 mL of solution of nanoparticles of platinum Pt-1 containing 500 μg/mL in DMSO are then added slowly drop-by-drop (about 1 mL/min) and with stirring. The stirring is maintained for 3 days.

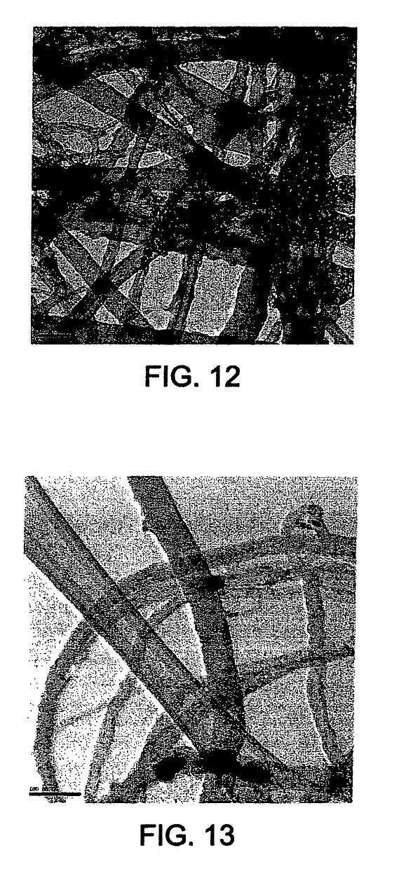

The deposition of particles on the nanotubes is observed by TEM on a drop of the composition obtained (FIG. 12).

The mass ratio of nanoparticles and nanotubes introduced is 1/1. The filtration of 200 mL of dispersion gives a difference in mass of 6.9 mg, on a carbon felt disk having an area of 44 cm², corresponding to 91% of the mass theoretically introduced. The effective density of nanoparticles is 77 μg/cm², corresponding to a density of pure platinum of about 62 g/cm².

### EXAMPLE 8

In a 500 mL flask container, 10.0 mg of nanotubes having an average initial length of 150 μm are added with 500 mL of isopropanol. An ultrasonic treatment is carried out this time for 4 times 15 minutes in a Transsonic® TI-H 15 ultrasonic tank at 90% of its maximum capacity and a frequency of 25 kHz. A dispersion is obtained called “dispersion D” below.

100 mL of this dispersion is taken by graduated cylinder and 4 mL of solution of nanoparticles of platinum Pt-1 containing 50 μg/mL in DMSO are added with stirring. The stirring of the mixture is then continued for four days.

The presence of isolated nanoparticles deposited on the surface of the nanotubes is observed by TEM on a drop of mixture sampled (FIG. 13).

The filtration of 10 mL of dispersion on a carbon felt disk (2.3 cm²) gives a difference in mass of 0.21 mg, corresponding to 100% of the mass introduced. The mass ratio of nanoparticles and nanotubes introduced is 1/10. The effective density of nanoparticles is 8.4 μg/cm², corresponding to a density of pure platinum of about 6.7 μg/cm².

### EXAMPLE 9

100 mL of the nanotube dispersion D of example 8 are taken by a graduated cylinder and 4 mL of solution of nanoparticles of platinum Pt-1 containing 10 μg/mL in DMSO are added drop-by-drop (about 1 mL/min) with stirring. The stirring is then continued for a few days.

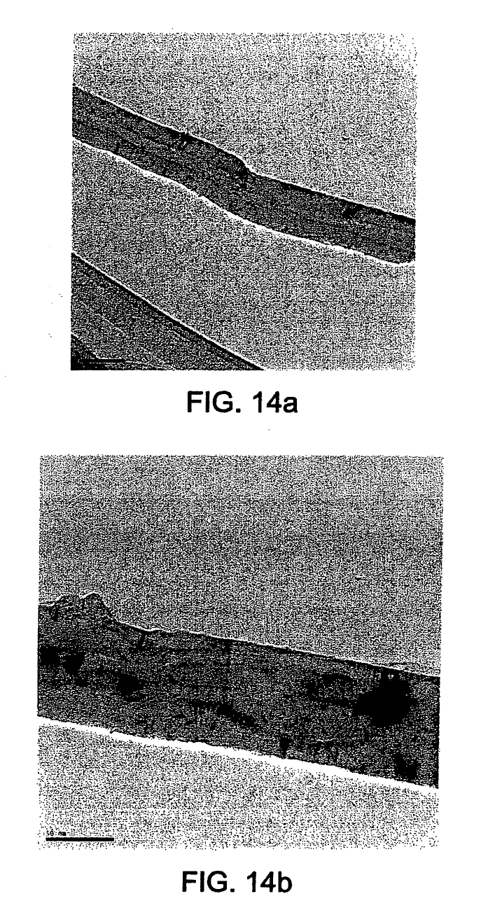

A drop of the medium is observed by TEM (FIG. 14a) showing the presence of nanoparticles on the nanotubes. The mass ratio of nanoparticles and nanotubes introduced is 1/50.

100 mL of nanotube dispersion D of example 8 are then again sampled and 4 mL of solution of nanoparticles of Pt-1 containing 5 μg/mL in DMSO are added drop-by-drop (about 1 mL/min) with stirring. The stirring is continued for a few days.

A drop of the medium is observed by TEM (FIG. 14b) showing the presence of nanoparticles on the carbon nanotubes.

10 mL of the medium is taken and filtered on a carbon felt disk (2.3 cm² area). The weighing indicates a filtration yield of 95%. The mass ratio of nanoparticles and nanotubes introduced is 1/100. The effective density of nanoparticles is 8.4 μg/cm², corresponding to a density of pure platinum of about 6.7 μg/cm².

### EXAMPLE 10

In a 500 mL container, 9.0 mg of nanotubes having an average initial length of 150 μm are introduced with 450 mL of isopropanol (20 mg/L). An ultrasonic treatment is carried out for 3 times 15 minutes in a Transsonic® TI-H 15 ultrasonic tank at 25 kHz and 90% of its maximum capacity. 18 mL of solution of Pt-0 nanoparticles containing 500 μg/mL in DMSO are then added with stirring and drop-by-drop (about 1 mL/min). Stirring is continued for a few days.

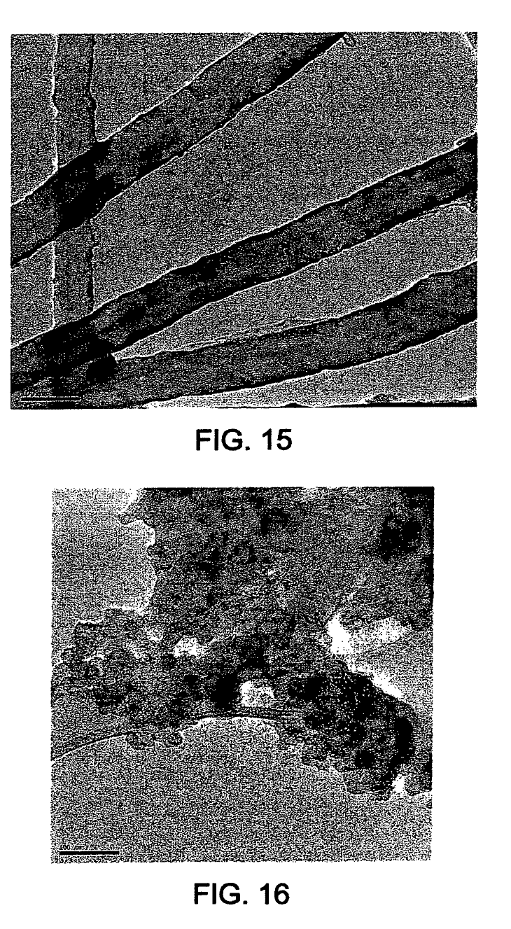

FIG. 15 shows a TEM image of a view of a drop of dispersion.

The filtration of 10 mL of dispersion on a carbon felt disk gives a difference in mass of 0.35 mg, corresponding to 90% of the mass introduced. The mass ratio of nanoparticles and nanotubes introduced is 1/1. The effective density of nanoparticles is 75 μg/cm², corresponding to a density of pure platinum of about 60 μg/cm².

### EXAMPLE 11

In a 250 mL container, 4.9 mg of Vulcan® XC-72 carbon black are introduced with 250 mL of isopropanol (20 mg/L). An ultrasonic treatment is carried out for about one minute in a Transsonic® TI-H 15 ultrasonic tank at 25 kHz and 90% of its maximum capacity, in order to disperse the carbon black. 8 mL of solution of Pt-1 nanoparticles containing 500 μg/mL in DMSO are then added with stirring. Stirring is continued for a few days.

FIG. 16 shows a TEM image of a view of a drop of dispersion.

The direct filtration of this dispersion on felt alone gives a lower yield because the carbon black particles are too small to fill the pores of the filter rapidly. The operation must then therefore be repeated several times (that is to say, the filtrate again filtered as many times as necessary) on a prior deposit of nanotubes alone. The filtration of 20 mL of dispersion in six passages gives a yield of about 69%, which is much lower than the yield obtained with nanotubes. An electrode is obtained with an estimated platinum density of 74 μg/cm². The mass platinum/carbon ratio in the dispersion is 4/5.

### EXAMPLE 12

15 mg of carbon fibers are cut out from carbon fabric and dispersed in a tube by vigorous stirring in 20 mL of isopropanol. The fibers are cut so that they are all millimeter-sized in order to be dispersed easily, and for their sampling to be possible and reproducible with stirring. 0.25 mL of solution of Pt-1 nanoparticles containing 50 μg/mL in DMSO is then added with stirring and stirring is continued for several days. 5 mL of dispersion taken by pipet are filtered on a 2.3 cm² carbon felt to form an electrode.

The composite of platinum Pt-1 nanoparticles/carbon fibers is obtained in an approximate mass proportion of 1/1000. The composite then filtered to prepare an electrode has a theoretical maximum pure platinum content of 1.1 μg/cm².

### EXAMPLE 13

The formation of a dual-porosity structure is demonstrated by preparing a dispersion containing a mixture of two types of structuring materials (carbon fibers and carbon nanotubes) and a volume of nanoparticles of type Pt-0, Pt-1 or Pt-4 platinum in solution in DMSO. Here, the platinum solution is added to an uncatalyzed fiber/nanotube mixture.

A few hundred milligrams of carbon fibers about a millimeter long and about 10 μm in diameter are cut from a carbon fabric. In a 1 liter container, 79 mg of carbon fibers, 15.5 mg of carbon nanotubes and 500 mL of isopropanol are introduced. An ultrasonic treatment is applied to the medium obtained in a Transsonic® TI-H 15 ultrasonic tank at 100% of its maximum capacity, for 80 minutes and in scanning mode at 25 kHz. This medium is called a carbon fiber/carbon nanotube medium below.

a) Structure Prepared from the Carbon Fiber/Carbon Nanotube Medium and Pt-0:

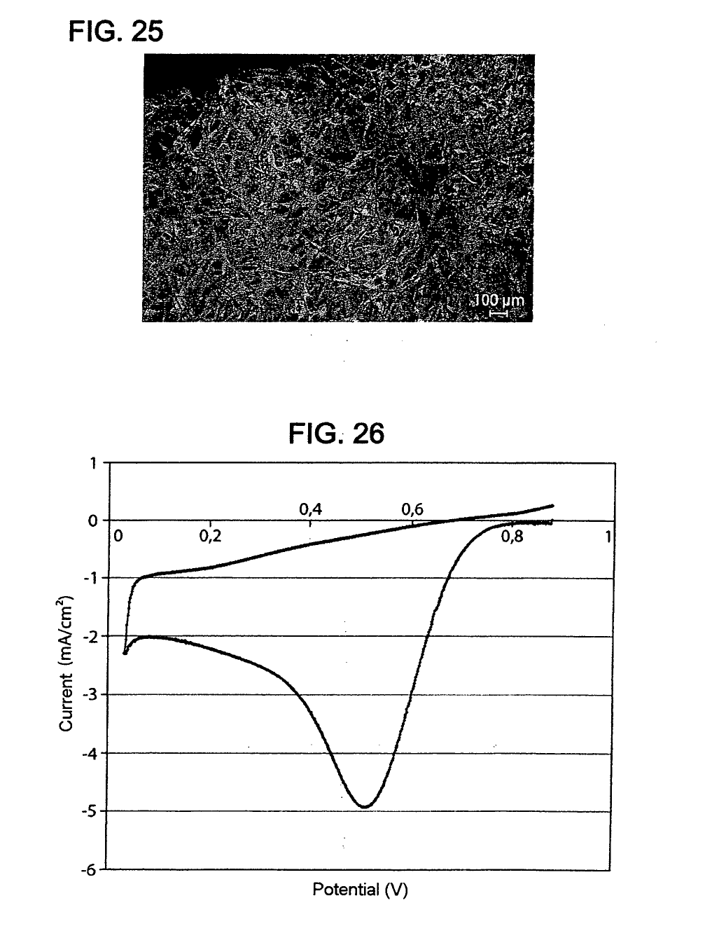

50 mL of the carbon fiber/carbon nanotube medium are taken and 0.150 mL of a solution of Pt-0 nanoparticles containing 0.98 mg/mL in DMSO is added with stirring. Stirring is continued for 36 hours. The filtration of 10 mL of this dispersion on a 2.3 cm² carbon felt disk gives an average difference in mass of 1.84 mg, corresponding to 96% of the mass introduced. The mass ratio of nanoparticles and carbonated element introduced (carbon fibers plus carbon nanotubes) is about 1/60. The effective density of platinum nanoparticles (with coating) is therefore about 12 μg/cm², corresponding to a density of pure platinum (without coating) of about 9 μg/cm². FIG. 25 shows an image recorded on the scanning electron microscope which illustrates the dual porosity of the layer obtained. FIG. 26 shows a voltammogram showing the electrochemical activity of the electrode relative to the reduction of oxygen. The reduction peak is observed at the potential of 0.50 V, and the peak current is −4.90 mA/cm².

b) Structure Prepared from the Carbon Fiber/Carbon Nanotube Medium and Pt-1:

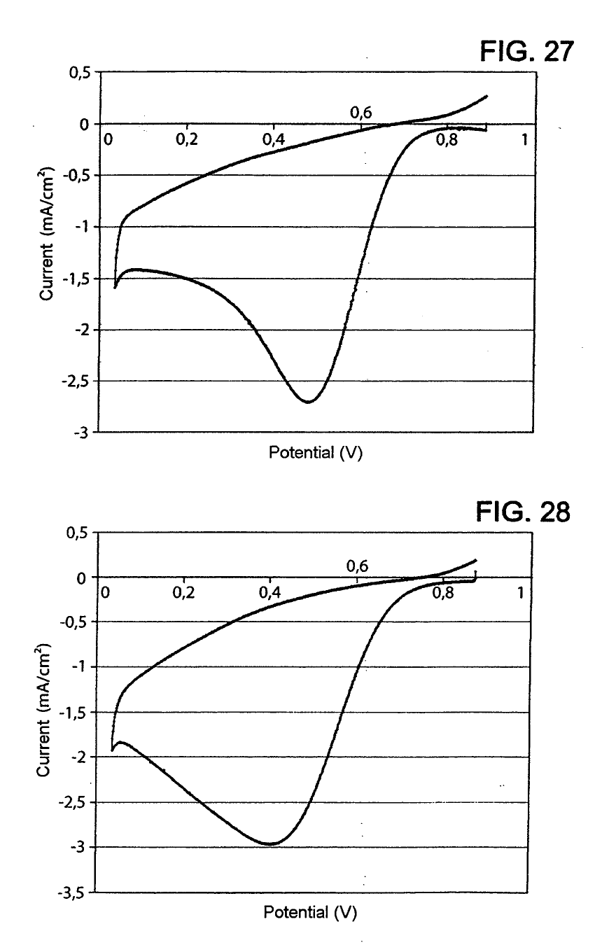

50 mL of the carbon fiber/carbon nanotube medium are taken and 0.29 mL of a solution of Pt-1 nanoparticles containing 0.51 mg/mL in DMSO is added with stirring. Stirring is continued for 36 hours. The filtration of 10 mL of this dispersion on a 2.3 cm² carbon felt disk gives an average difference in mass of 1.89 mg, corresponding to 99% of the mass introduced. The mass ratio of nanoparticles and carbonated element introduced (carbon fibers plus carbon nanotubes) is about 1/60. The effective density of platinum nanoparticles (with coating) is therefore about 13 μg/cm², corresponding to a density of pure platinum (without coating) of about 10 μg/cm². FIG. 27 shows a voltammogram showing the electrochemical activity of the electrode relative to the reduction of oxygen. The reduction peak is observed at the potential of 0.42 V, and the peak current is −2.7 mA/cm².

c) Structure Prepared from the Carbon Fiber/Carbon Nanotube Medium and Pt-4:

50 mL of the carbon fiber/carbon nanotube medium are taken and 0.51 mL of a solution of Pt-4 nanoparticles containing 0.292 mg/mL in DMSO is added with stirring. Stirring is continued for 36 hours. The filtration of 10 mL of this dispersion on a 2.3 cm² carbon felt disk gives an average difference in mass of 1.75 mg, corresponding to 92% of the mass introduced. The mass ratio of nanoparticles and carbonated element introduced (carbon fibers plus carbon nanotubes) is about 1/60. The effective density of platinum nanoparticles (with coating) is therefore about 12 μg/cm², corresponding to a density of pure platinum (without coating) of about 9 μg/cm². FIG. 28 shows a voltammogram showing the electrochemical activity of the electrode relative to the reduction of oxygen. The reduction peak is observed at the potential of 0.40 V, and the peak current is −2.95 mA/cm².

### EXAMPLE 14

Here, a volume of a Pt/NT dispersion is added in proportion 1/2 to a dispersion consisting of a mixture of fibers and uncatalyzed nanotubes.

80 mL of the carbon fiber/carbon nanotube medium of example 13 are taken and 1 mL of a dispersion having a Pt/Nt ratio of 1/2 is added, prepared with Pt-1 and in a nanotube concentration of 20 μg/mL. The filtration of 10 mL of this dispersion on a 2.3 cm² carbon felt disk gives an average difference in mass of 1.86 mg, corresponding to 99% of the mass introduced.

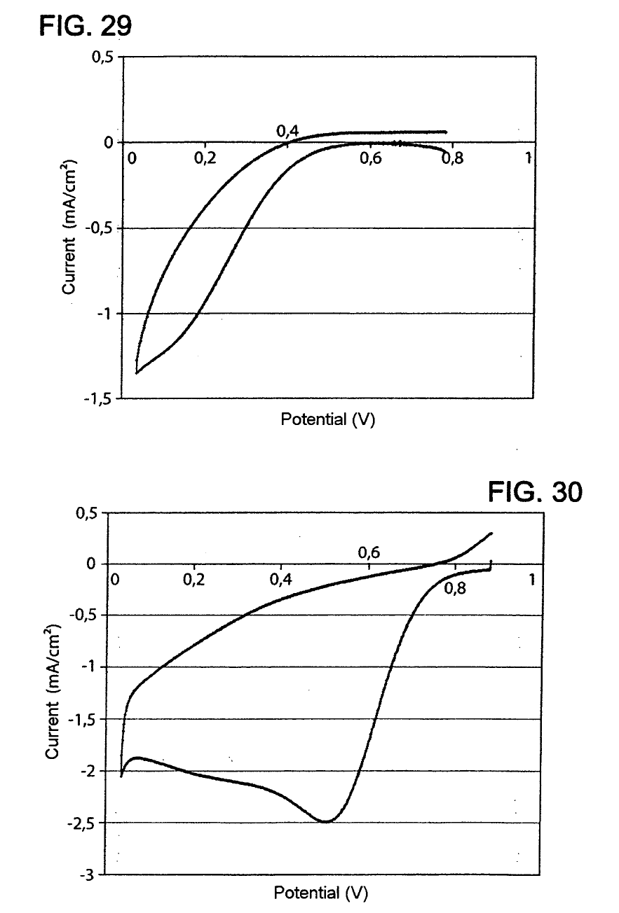

The mass ratio of nanoparticles and carbonated element introduced (carbon fibers plus carbon nanotubes) is about 1/1500. The effective density of platinum nanoparticles (with coating) is therefore about 0.5 μg/cm², corresponding to a density of pure platinum (without coating) of about 0.4 μg/cm². FIG. 29 shows a voltammogram showing the electrochemical activity of the electrode relative to the reduction of oxygen. The reduction peak is observed at the potential of 0.09 V, and the peak current is −1.25 mA/cm².

### EXAMPLE 15

Here, another volume of a Pt/NT dispersion is added in proportion 1/2 to a dispersion consisting of a mixture of fibers and uncatalyzed nanotubes.

80 mL of the carbon fiber/carbon nanotube medium of example 13 are taken and 10 mL of a dispersion having a Pt/Nt ratio of 1/2 is added, prepared with Pt-1 and in a nanotube concentration of 20 μg/mL. The filtration of 10 mL of this dispersion on a 2.3 cm² carbon felt disk gives an average difference in mass of 1.86 mg, corresponding to 99% of the mass introduced. The mass ratio of nanoparticles and carbonated element introduced (carbon fibers plus carbon nanotubes) is about 1/1500. The effective density of platinum nanoparticles (with coating) is therefore about 5 μg/cm², corresponding to a density of pure platinum (without coating) of about 4 μg/cm². FIG. 30 shows a voltammogram showing the electrochemical activity of the electrode relative to the reduction of oxygen. The reduction peak is observed at the potential of 0.50 V, and the peak current is −2.50 mA/cm².

### EXAMPLE 16

Here, a volume of a Pt/NT dispersion is added in proportion 1/10 to a dispersion consisting of a mixture of fibers and uncatalyzed nanotubes.

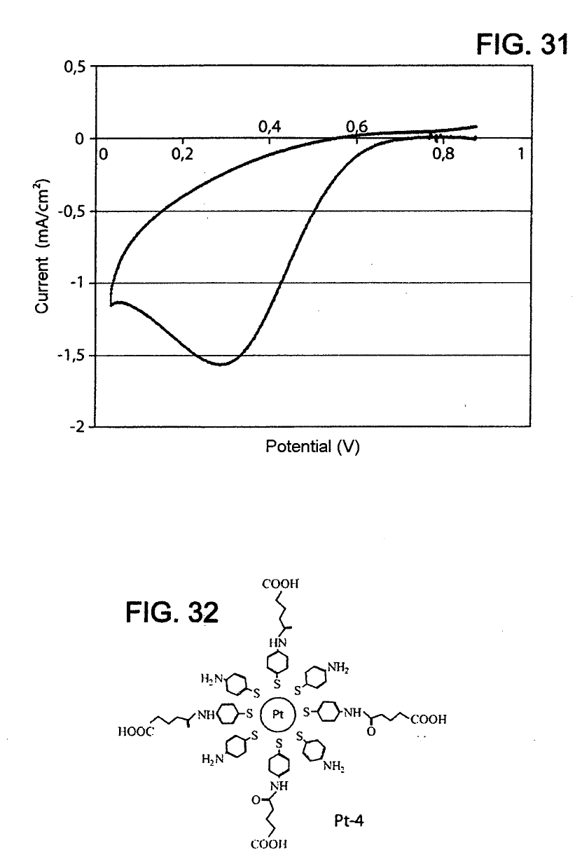

80 mL of the carbon fiber/carbon nanotube medium of example 13 are taken and 10 mL of a dispersion having a Pt/Nt ratio of 1/10 is added, prepared with Pt-1 and in a nanotube concentration of 20 μg/mL. The filtration of 10 mL of this dispersion on a 2.3 cm² carbon felt disk gives an average difference in mass of 1.86 mg, corresponding to 99% of the mass introduced. The mass ratio of nanoparticles and carbonated element introduced (carbon fibers plus carbon nanotubes) is about 1/1500. The effective density of platinum nanoparticles (with coating) is therefore about 1 g/cm², corresponding to a density of pure platinum (without coating) of about 0.7 μg/cm². FIG. 31 shows a voltammogram showing the electrochemical activity of the electrode relative to the reduction of oxygen. The reduction peak is observed at the potential of 0.28 V, and the peak current is −1.55 mA/cm².

### EXAMPLE 17

An exemplary embodiment is shown of a dispersion in water in which the first solvent is an aqueous medium with an acidic pH and the second solvent is an aqueous medium with a basic pH.

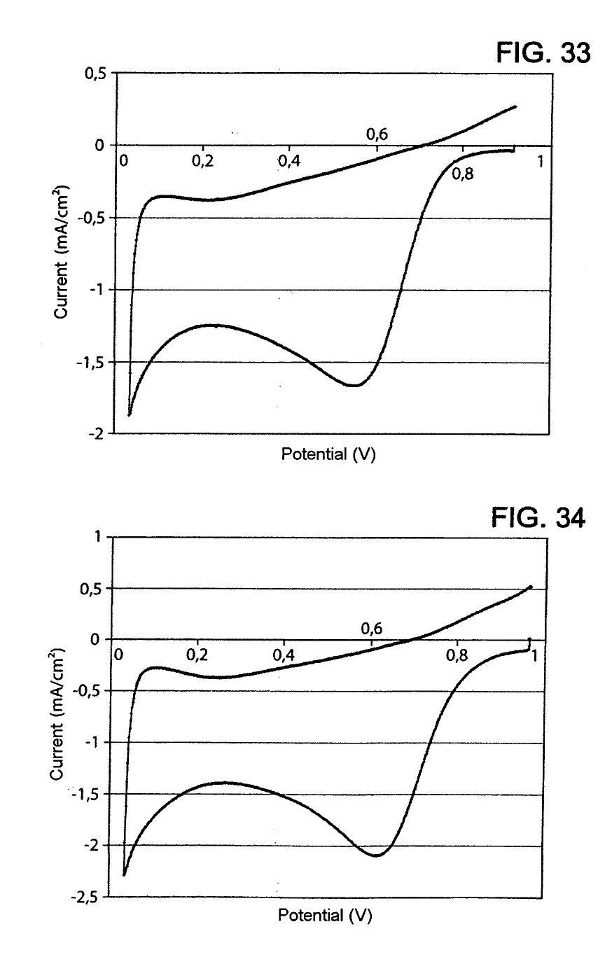

In a 500 mL container, 5 mg of carbon nanotubes are introduced and 250 mL of water are added. An ultrasonic treatment is applied to the medium obtained 5 times in succession in a Transsonic® TI-H 15 ultrasonic tank at 100% of its maximum capacity, for 10 minutes and in scanning mode at 25 kHz. The mixture is then subjected to vigorous mechanical stirring for 1 to 2 minutes. 80 mL of this medium is taken and made slightly acidic by adding 2 drops of 3.7% hydrochloric acid. 1.63 mL of an aqueous solution having a pH of 12 of Pt-4 nanoparticles containing 0.493 mg/mL are then added drop-by-drop to the medium with continued stirring. Stirring is continued for 24 hours. The filtration of 10 mL of this dispersion on a carbon felt disk gives an average difference in mass of 0.25 mg, corresponding to 83% of the mass introduced. The mass ratio of nanoparticles and nanotubes introduced is 1/2. The effective density of platinum nanoparticles (with organic coating) is 35 μg/cm², corresponding to a density of pure platinum (without coating) of about 26 μg/cm². FIG. 33 shows a voltammogram showing the electrochemical activity of the electrode relative to the reduction of oxygen. The reduction peak is observed at the potential of 0.54 V, and the peak current is −1.65 mA/cm².

### EXAMPLE 18

Another exemplary embodiment is shown of a dispersion in water in which the first solvent is an aqueous medium with an acidic pH and the second solvent is an aqueous medium with a basic pH.

In a 500 mL container, 5.2 mg of carbon nanotubes are introduced and 250 mL of water are added. An ultrasonic treatment is applied to the medium obtained in 10 minutes in pulsed mode (that is to say alternately 1 second of ultrasound and 1 second pause), using a Bioblock Vibracell probe at 40% of its maximum capacity. 80 mL of this medium is taken and made slightly acidic by adding 2 drops of 3.7% hydrochloric acid. 1.68 mL of an aqueous solution having a pH of 12 of Pt-4 nanoparticles containing 0.495 μg/mL are then added drop-by-drop to the medium with continued stirring. Stirring is continued for 24 hours. The filtration of 10 mL of this dispersion on a 2.3 cm² carbon felt disk gives an average difference in mass of 0.27 mg, corresponding to 87% of the mass introduced. The mass ratio of nanoparticles and nanotubes introduced is 1/2. The effective density of platinum nanoparticles (with organic coating) is 37 μg/cm², corresponding to a density of pure platinum (without coating) of about 27 μg/cm². FIG. 34 shows a voltammogram showing the electrochemical activity of the electrode relative to the reduction of oxygen. The reduction peak is observed at the potential of 0.61 V, and the peak current is −2.10 mA/cm².

### EXAMPLE 19

An exemplary embodiment is shown of a dispersion and its deposition by direct spraying on a carbonated support.

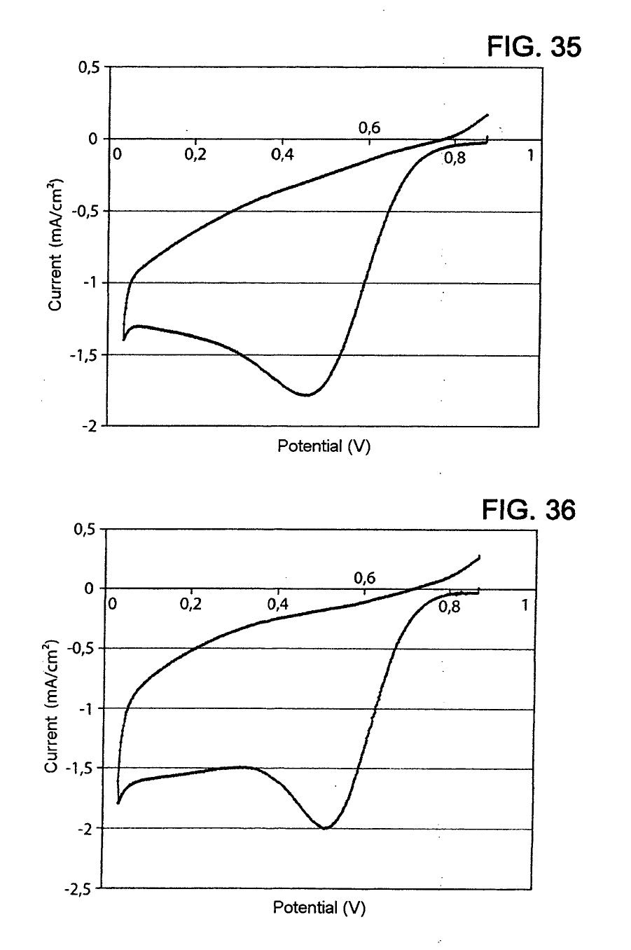

In a 100 mL container, 19.6 mg of carbon nanotubes are introduced and 60 mL of isopropanol are added. An ultrasonic treatment is applied to the medium obtained for 10 minutes in pulsed mode (that is to say alternately 1 second of ultrasound and 1 second pause) using a Bioblock Vibracell at 40% of its maximum capacity. 12.4 mL of a solution of Pt-1 nanoparticles in DMSO containing 0.53 mg/mL are then added to the medium maintained under stirring and drop-by-drop (1 mL/minute). After 36 hours of stirring, 2.5 mL of the dispersion are taken using a pipet and spread by drop-by-drop spraying on the entire surface of a 27 cm² carbon felt, previously weighed and placed on an absorbent paper. The electrode is then dried under rough vacuum and weighed. The gain in mass after the deposition and after drying is 0.86 mg for a theoretical gain in mass of 0.9 mg. The deposition yield is therefore higher than 95%. The mass ratio of nanoparticles and nanotubes introduced is 1/3, the effective density of platinum nanoparticles (with coating) is 8.0 μg/cm², or about 6.0 μg of pure platinum (without coating) per square centimeter. From this 27 cm² electrode, several circular electrodes having an area of 3.14 cm³ are cut out. Several electrodes are tested with regard to the reduction of oxygen and yield similar electrochemical responses to the one shown in FIG. 35. The reduction peak is observed at the potential of 0.45 V, and the peak current is −1.80 mA/cm².

### EXAMPLE 20

Another exemplary embodiment is shown of a dispersion and its deposition by direct spraying on a carbonated support.

In a 100 mL container, 19.6 mg of carbon nanotubes are introduced and 60 mL of isopropanol are added. An ultrasonic treatment is applied to the medium obtained for 10 minutes in pulsed mode (that is to say alternately 1 second of ultrasound and 1 second pause) using a Bioblock Vibracell at 40% of its maximum capacity. 12.4 mL of a solution of Pt-1 nanoparticles in DMSO containing 0.53 mg/mL are then added to the medium maintained under stirring and drop-by-drop at a rate of 1 mL/second. After 36 hours of stirring, 2.5 mL of the dispersion are taken using a pipet and spread by drop-by-drop spraying on the entire surface of a 30 cm² carbon felt, previously weighed and placed on an absorbent paper. The electrode is then dried under rough vacuum and weighed. Four additional sequences comprising a spraying of 2.5 mL of the solution followed by drying under rough vacuum are carried out. The total gain in mass of the deposit is 4.30 mg for a theoretical gain in mass of 4.5 mg. The deposition yield is therefore higher than 95%. The mass ratio of nanoparticles and nanotubes introduced is 1/3, the effective density of platinum nanoparticles is 37 μg/cm², or about 27 μg of pure platinum per square centimeter. FIG. 36 shows a typical response of the electrochemical activity on a 3.14 cm² electrode cut out of the 30 cm² electrode with regard to the reduction of oxygen. The reduction peak is observed at the potential of 0.51 V, and the peak current is −2.00 mA/cm².

### EXAMPLE 21

An example is shown of the introduction of Nafion into the dispersion. Here, the deposition yields of the dispersion are low.

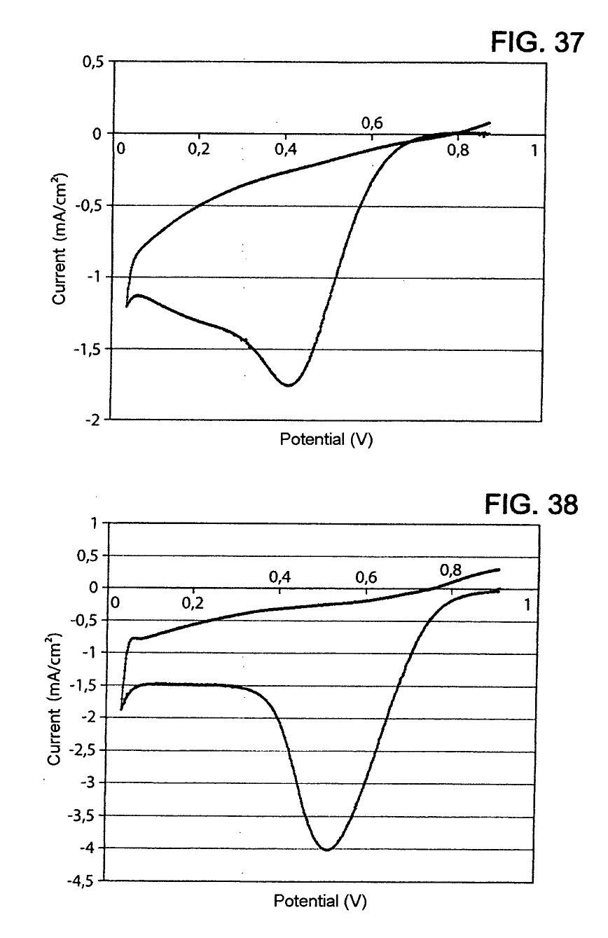

In a 100 mL container, 18.3 mg of carbon nanotubes are introduced and 60 mL of isopropanol are added. An ultrasonic treatment is applied to the medium obtained in a Transsonic® TI-H 15 ultrasonic tank at 100% of its maximum capacity, for 110 minutes and in scanning mode at 25 kHz. 12.2 mL of a solution of Pt-1 nanoparticles in DMSO containing 0.496 mg/mL are then added to the medium maintained under stirring and drop-by-drop at a rate of 1 mL/second. After 36 hours of stirring, 0.1 mL of Nafion® containing 10% by weight in water is added and the medium stirred vigorously using a Vibramax 100 (Heidolph) stirrer at maximum speed for 90 minutes. Using a pipet, 2.5 mL of dispersion are then taken and spread by spraying drop-by-drop on the entire surface of a 30 cm² carbon felt, previously weighed and placed on an absorbent paper. The electrode is then dried under rough vacuum at a temperature of 60° C. and weighed. The total gain in mass of the deposit is 1.37 mg for a theoretical gain in mass of 2.14 mg. The deposition yield is therefore higher than 64%, due to the porosity of the felt and the fact that the dispersion is more finely divided because of the addition of Nafion. The mass ratio of nanoparticles and nanotubes introduced is 1/3 in the formulation, the effective density of platinum nanoparticles (with coating) is about 4.5 μg/cm², or about 3.4 μg of pure platinum per square centimeter. FIG. 37 shows a typical response relative to the reduction of oxygen on a 3.14 cm² electrode cut out of the 30 cm² electrode. The reduction peak is observed at the potential of 0.40 V, and the peak current is −1.75 mA/cm².

### EXAMPLE 22

Another example is shown of the introduction of Nafion into the dispersion. In a 100 mL container, 18.3 mg of carbon nanotubes are introduced and 60 mL of isopropanol are added. An ultrasonic treatment is applied to the medium obtained in a Transsonic® TI-H 15 ultrasonic tank at 100% of its maximum capacity, for 110 minutes and in scanning mode at 25 kHz. 12.2 mL of a solution of Pt-1 nanoparticles in DMSO containing 0.496 mg/mL are then added to the medium maintained under stirring and drop-by-drop at a rate of 1 mL/second. After 36 hours of stirring, 0.1 mL of Nafion® containing 10% by weight in water is added and the medium stirred vigorously using a Vibramax 100 (Heidolph) stirrer at maximum speed for 90 minutes. Using a pipet, 2.5 mL of dispersion are then taken and spread by spraying drop-by-drop on the entire surface of a 30 cm² carbon felt, previously weighed and placed on an absorbent paper. The electrode is then dried under rough vacuum at a temperature of 60° C. and weighed. The total gain in mass of the deposit is 5.7 mg for a theoretical gain in mass of 12.88 mg. The deposition yield is therefore higher than 43.5%, due to the porosity of the felt and the fact that the dispersion is more finely divided because of the addition of Nafion® . The mass ratio of nanoparticles and nanotubes introduced is 1/3, the effective density of platinum nanoparticles (with coating) is about 18 μg/cm², or about 13.5 μg of pure platinum per square centimeter. FIG. 38 shows a typical response relative to the reduction of oxygen on a 3.14 cm² electrode cut out of the 30 cm² electrode. The reduction peak is observed at the potential of 0.51 V, and the peak current is −4.00 mA/cm².

### EXAMPLE 23

Here, it is shown that the deposition of a layer of nanotubes by filtration serves to recover the high deposition yields when the dispersion contains Nafion.

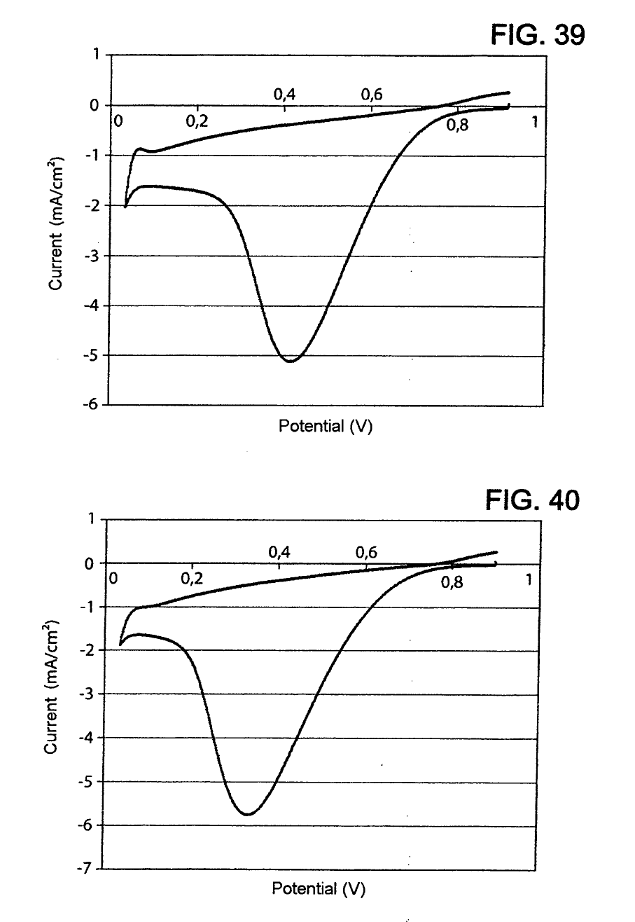

In a 1.5 liter container, 39.3 mg of carbon nanotubes are introduced, and 1. liter of isopropanol is added. An ultrasonic treatment is applied to the medium obtained in a Transsonic® TI-H 15 ultrasonic tank at 100% of its maximum capacity for 100 minutes, in scanning mode at 25 kHz. On a felt surface of 38 cm² previously weighed, 200 mL of this dispersion are filtered. After drying, the mass of nanotube deposited is 7.83 mg for a theoretical mass of 7.86 mg (that is to say with a yield of nearly 100%). 5 mL of the dispersion described in example 22 are distributed uniformly, by spreading using a pipet, on the deposit of nanotubes present on the carbon felt. The felt is placed on a hot plate heated to about 70° C. The electrode is then dried under vacuum for 60 minutes and an increase in mass of 5.51 mg is measured for a theoretical increase in mass of 4.29 mg. The deposition yield here is therefore more than 110%. An additional drying of 60 minutes at 80° C. does not cause any additional loss of mass, so that solvents are probably trapped in the structure. It is therefore shown that the deposition of a dispersion containing Nafion® (example 22) on a support with adapted porosity serves to obtain sprayings with a high yield. Considering the concentration of platinum nanoparticles in the dispersion of example 22, a platinum density of about 11.1 μg/cm² is calculated, corresponding to about 8.3 μg/cm² of pure platinum. FIG. 39 shows a typical response relative to the reduction of oxygen on a 3.14 cm² electrode cut out of the 38 cm² electrode. The reduction peak is observed at the potential of 0.41 V, and the peak current is −5.11 mA/cm².

### EXAMPLE 24

Here it is shown that the deposition of a layer of nanotube by spraying on a carbon support serves to recover the high deposition yields when the dispersion contains Nafion.

This example is similar to example 23 with the exception that the deposition of nanotube prior to the deposition of the dispersion of example 22 is carried out by spraying and not by filtration of a nanotube dispersion without platinum.

35 mg of carbon nanotube is introduced in a 100 mL container and 80 mL of isopropanol are added. An ultrasonic treatment is applied to the medium obtained in a Transsonic® TI-H 15 ultrasonic tank at 100% of its maximum capacity for 110 minutes, in scanning mode at 25 kHz. Using a pipet, 15 mL of this medium are deposited uniformly on a felt surface of about 25 cm², previously weighed and placed on a hot plate at about 70° C. The theoretical mass of nanotubes deposited is 6.56 mg. After drying, an increase in mass of 6.21 mg is measured, representing a carbon nanotube deposition yield of 94.6%. On the same surface placed back on the hot plate, using a pipet, 2.5 mL of the dispersion of example 22 are spread uniformly. After drying under vacuum, an increase in weight of 2.03 mg is measured for a theoretical value of 2.14 mg. The yield is therefore about 95%. Considering the concentration of platinum nanoparticles in the dispersion of example 22, a platinum density of about 8.0 μg/cm² is calculated, corresponding to about 6 μg/cm² of pure platinum. FIG. 40 shows a typical response relative to the reduction of oxygen on a 3.14 cm² electrode cut out of the 25 cm² electrode. The reduction peak is observed at the potential of 0.33 V, and the peak current is −5.75 mA/cm².

### EXAMPLE 25

Here two things are shown simultaneously:
a deposit can be prepared by spraying a dispersion with two structuring carbonated elements containing Nafion with a good deposition yield on a support having adapted porosity, and
a dual-porosity structure is clearly obtained in these conditions.

In this example, it is shown that deposits by spraying can also be produced on supports with adapted porosity from a dispersion like the one in example 13b containing two structuring carbonated elements such as carbon nanotubes and carbon fibers, to which Nafion has been added.

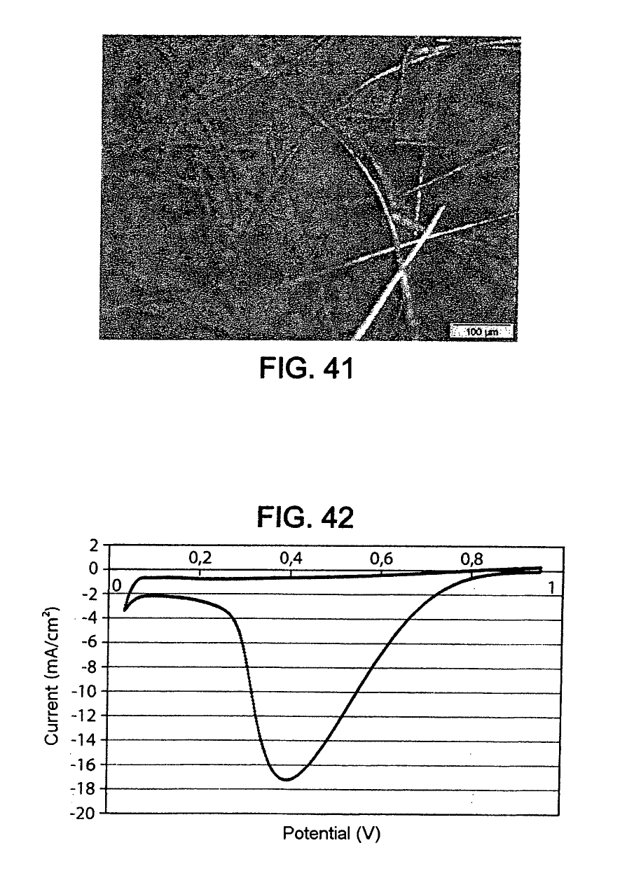

As in example 24, an electrode is prepared provided with a nanotube deposit produced by spraying with pipet on a felt area of about 25 cm². An area of 7 cm² is cut out of this electrode and weighed. In a volume of 40 mL of the dispersion used in example 13b, 0.230 mL of a 10% solution of Nafion in water and previously diluted 10 times is added. The medium is left under stirring for one hour. The 7 cm² electrode is then placed on a hot plate heated to about 80° C. and using a pipet, 25.6 mL of the dispersion is spread slowly and uniformly on an area of about 5 cm². The sample is then placed under rough vacuum for 120 minutes and then in an oven heated to 80° C. for 20 minutes. After drying, an increase in mass of 7.92 mg is measured for a theoretical mass of 6.45 mg. The yield above 100% shows that solvents remain trapped in the structure, probably due to the presence of the Nafion®. Considering the properties of the dispersion in example 13b, a nanoparticle density of about 15.3 μg/cm² is calculated, corresponding to a density of pure platinum of about 11.5 μg/cm². FIG. 41 shows an image taken by optical microscope of the sample, showing that a dual-porosity structure is obtained, similar to the one in example 13. FIG. 42 shows a response of the electrochemical activity of a 3.14 cm² electrode cut out of a 5 cm² electrode relative to the reduction of oxygen. The reduction peak is observed at the potential of 0.39 V, and the peak current is −17.21 mA/cm².

### Electro-Catalytic Activity of the Compounds Obtained

The samples obtained by filtration of a nanoparticle/nanotube assembly on carbon felt are tested in the following electrochemical conditions. A conventional three-electrode rig is prepared, preferably with a normal hydrogen electrode, in a 1 mol/L perchloric acid solution saturated with oxygen under 1 bar pure oxygen. The scanning rate is 100 mV/s.

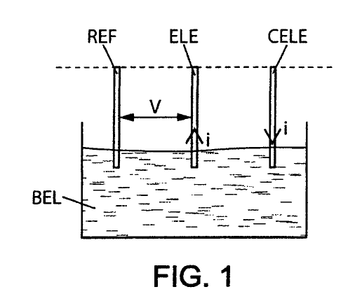

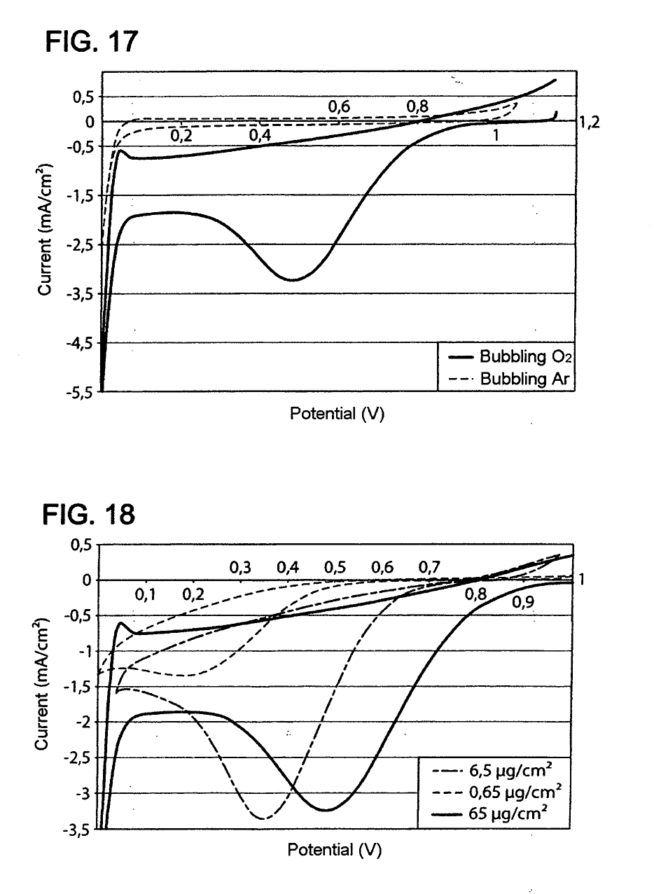

FIG. 17 shows a voltammogram (current-voltage curve with, on the x-axis, the potential V in a sample ELE, relative to the reference selected REF, and, on the y-axis, the current i flowing in the sample ELE and the counter-electrode CELE, as shown in FIG. 1). This voltammogram of FIG. 17 is characteristic of the electrochemical response of the reduction of aqueous oxygen for the series of example 7 (solid curve) for which it is recalled that the samples are obtained by filtering 10 mL of dispersion on a carbon felt, for obtaining a platinum content of about 67 μg/cm². FIG. 17 compares this voltammogram with the one (dotted curve) of the same sample in a solution containing no oxygen (oxygen removed by bubbling argon in the solution). The oxygen reduction peak occurs at the potential of 0.48 V and is −3.2 mA/cm².

This response is compared to the one obtained for much lower platinum ratios (1/100 (dotted lines) and 1/10 (long/short broken lines) according to examples 9 and 8). FIG. 18 shows that an oxygen reduction current is obtained with examples 8 and 9 that is not negligible in comparison with the reference (solid line) of example 7 (ratio 1/1). These electrodes containing very low platinum fillers (ratios 1/10 and 1/100) can therefore normally be used in a fuel cell without an excessive loss of performance in comparison with the usual fillers of several hundred μg/cm².

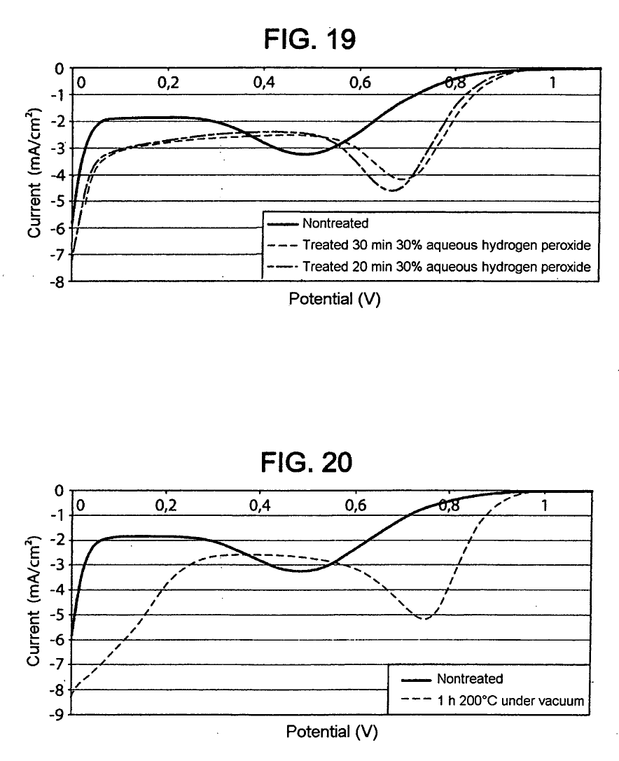

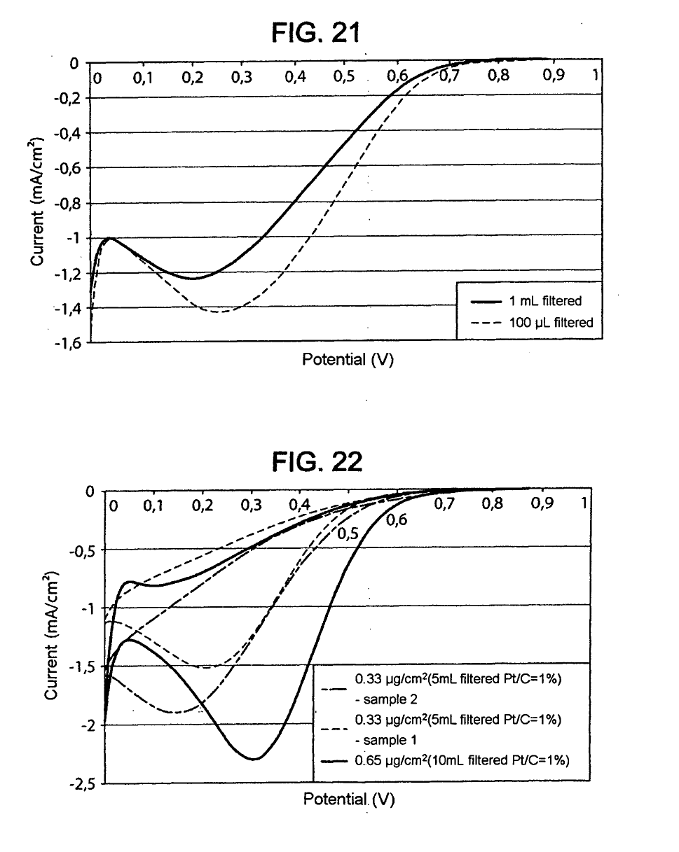

As stated above, this performance can be further improved by treating the electrodes chemically with hydrogen peroxide. FIG. 19 shows the voltammograms of the electrodes initially containing 65 μg/cm² of platinum (according to example 7):
without chemical treatment (solid curve),
with treatment for 20 minutes with 30% hydrogen peroxide (dotted curve), and
with treatment for 30 minutes with 30% hydrogen peroxide (long/short broken curve).

Only the “forward” scanning (and not the complete hysteresis) is shown for greater clarity in FIG. 19.

It should be observed that the treatment with hydrogen peroxide causes a loss of deposit, therefore of platinum, due to the liberation of gas during the treatment, increasing as the treatment is longer (long/short broken curve). The electrodes therefore contain less filler that initially.

As an alternative, a heat treatment at 200° C. under vacuum for 1 to 2 hours yields similar increases in performance. This heat treatment causes no significant loss of platinum. FIG. 20 shows this improvement.

Furthermore, it was checked by scanning electron microscope that the two types of treatment (heat and chemical) do not modify the morphology of the deposit of nanoparticles on the surface of the nanotubes.
Possibility of Decreasing the Platinum Content

The platinum content can also be reduced by decreasing the filtered volume or by diluting the dispersions obtained.

With reference to FIG. 20, the results are presented for two equivalent contents (about 0.65 μg/cm²) obtained:

from 100 μL of dispersion containing 20 mg/L of nanotubes (solid curve), and

from 1 mL of dispersion containing 2 mg/L (dotted curve), corresponding to the previous solution diluted ten times.

To improve their performance, the electrodes were heat treated (1 to 2 h at 200° C. under vacuum). Considering the uncertainties on the mass deposited and on the oxygen concentration in solution, it can be considered that the two samples respond very similarly.

The electrodes containing the lower platinum content tested (and of which the electro-catalytic activity was nevertheless demonstrated) were prepared with a dispersion of composite of platinum nanoparticles/carbon nanotubes:

containing 1% platinum,

20 mg/L of nanotubes, and

5 mL of dispersion filtered on carbon felt.

The electrodes obtained were then heat treated at 200° C. and then tested in a three-electrode electrochemical cell.

FIG. 22 shows the response of two of these electrodes (platinum density 0.33 μg/cm²—dotted lines and long/short broken lines) compared with an electrode with two times more platinum (10 mL of the same filtered dispersion—0.65 μg/cm² of platinum—solid line). Considering the uncertainties, the reproducibility of the results is good.
Results Obtained with Particular Embodiments of the Structuring Material

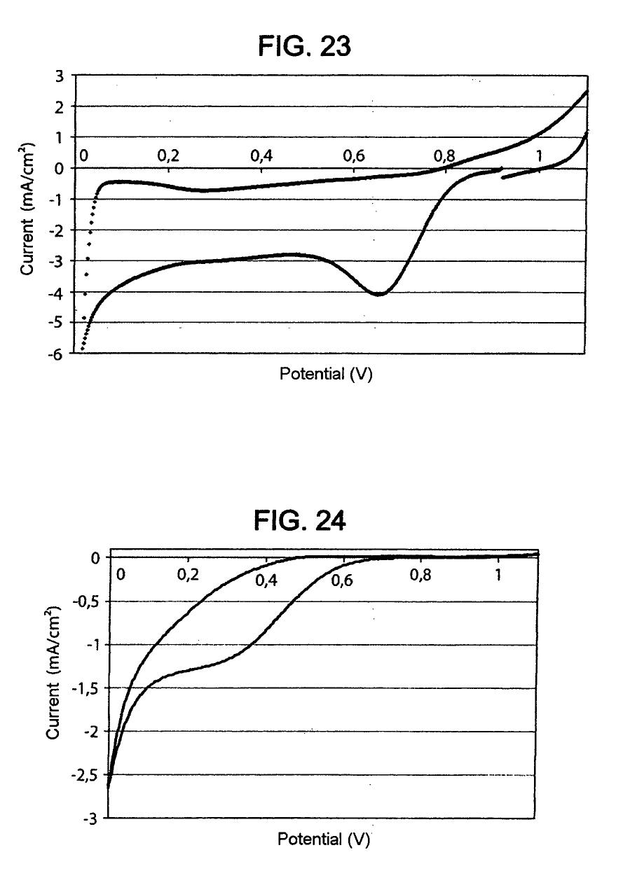

The samples prepared from similar embodiments to those of example 11 also reveal catalytic activity, with an aqueous oxygen reduction peak, as shown in FIG. 23. Here, 20 mL of dispersion containing carbon black were used, filtered in a single passage on a prior deposit of nanotubes, with an estimated filtration yield of 36% and an estimated platinum content of 39 μg/cm². This sample was not pretreated.

The samples issuing from example 12 also reveal catalytic activity, as shown in FIG. 23. Here, 5 mL of dispersion were filtered. The theoretical maximum platinum content is estimated at 1.1 μg/cm². The shoulder observed is attributed to the reduction of aqueous oxygen on the surface of the platinum. This sample was not pretreated.

1. A method for preparing a catalytic composition comprising a carbonated structuring material combined with a catalyst, comprising the steps of:
preparing a mixture of a solution of a first solvent comprising a carbonated structuring material and a solution of a second solvent comprising the catalyst,
stirring the resulting mixture until the catalyst precipitates on the carbonated structuring material,
said catalyst and said structuring material being insoluble in the mixture of the first and second solvents.

2. The method as claimed in claim 1, wherein the catalyst is deposited on the structuring material during said precipitation.

3. The method as claimed in claim 1, wherein the carbonated structuring material comprises carbon nanotubes.

4. The method as claimed in claim 1, wherein the carbonated structuring material comprises carbon black.

5. The method as claimed in claim 1, wherein the carbonated structuring material comprises carbon fibers.

6. (canceled)

7. The method as claimed in claim 1, wherein the catalyst comprises metal particles.

8. The method as claimed in claim 7, wherein said metal particles comprise at least one platinoid.

9. The method as claimed in claim 8, wherein said particles have a nanometer size and comprise an organic coating of the platinoid.

10. The method as claimed in claim 1, wherein the first solvent is a hydroxylated solvent selected from isopropanol, methanol, ethanol, a glycol such as ethylene glycol, and/or a mixture thereof.

11. The method as claimed in claim 1, wherein the second solvent is of the dichloromethane, dimethylsulfoxide, chloroform type and/or a mixture of these solvents.

12. The method as claimed in claim 1, wherein the catalyst is insoluble in the first solvent.

13. The method as claimed in claim 1, wherein the solubility of the catalyst in the first solvent and/or in the mixture is lower than 10⁻⁹ mol/L.

14. The method as claimed in claim 1, wherein the concentration of the carbonated structuring material in the first solvent is between 1 mg/L and 10 g/L.

15. The method as claimed in claim 14, wherein the concentration of the carbonated material is a few tens of milligrams per liter.

16. The method as claimed in claim 1, wherein the concentration of the carbonated structuring material in the second solvent is between 1 mg/L and 10 g/L.

17. The method as claimed in claim 16, wherein the concentration of the catalyst in the second solvent is about a few hundred micrograms per milliliter.

18. The method as claimed in claim 1, wherein the mixture comprises more of the first solvent including the carbonated structuring material than of the second solvent including the catalyst.

19. The method as claimed in claim 18, wherein the volumetric ratio of the second solvent comprising the catalyst to the first solvent comprising the carbonated structuring material is lower than 1 to 5 and preferably about 1 to 25.

20. The method as claimed in claim 1, wherein the second solvent including the catalyst is added to the first solvent including the carbonated structuring material, in small successive quantities, to form said mixture.

21. The method as claimed in claim 1, wherein the mixture is subjected to mechanical stirring to substantially uniformly distribute the catalyst on the carbonated structuring material.

22. The method as claimed in claim 21, wherein the mechanical stirring is activated at least until an optical appearance of the mixture is obtained that is close to an optical appearance of a catalyst-free solution.

23. The method as claimed in claim 22, wherein the mechanical stirring is activated or stopped according to an optical reading (LO) of a supernatant in the mixture.

24. The method as claimed in claim 1, further comprising a step of applying an ultrasonic treatment at least to the carbonated structuring material in the first solvent.

25. The method as claimed in claim 24, wherein the carbonated structuring material comprises carbon nanotubes and the ultrasonic treatment separates nanotubes in aggregates and/or breaks at least part of the nanotubes to reduce their size.

26. The method as claimed in claim 1, wherein a surfactant is added at least to the first solvent comprising the carbonated structuring material and/or to the mixture.

27. The method as claimed in claim 26, wherein the surfactant is Nafion®.

28. The method as claimed in claim 1, further comprising a step of separating and extracting the catalytic composition comprising the carbonated structuring material combined with the catalyst, from the mixture.

29. The method as claimed in claim 28, wherein the catalytic composition is extracted by filtering or spraying on a porous support.

30. The method as claimed in claim 28, wherein said particles have a nanometer size and comprise an organic coating of the platinoid, the method further comprising a step of chemical or heat treatment of said catalytic composition to remove said organic coating.

31. The method as claimed in claim 1, wherein the catalytic composition has an electrochemical behavior adjustable according to:
on the one hand, the volume load of the catalyst in the composition, and
on the other hand, the surface density of the catalyst in the composition,
the method comprising a joint control of at least two parameters:
on the one hand, a total volume of catalytic composition in suspension in the mixture, and
on the other hand, a mass proportion of the carbonated material with regard to the catalyst.

32. A catalytic composition comprising a carbonated structuring material combined with a catalyst, saif composition being obtained by implementation of the a method comprising the steps of:
preparing a mixture of a solution of a first solvent comprising a carbonated structuring material and a solution of a second solvent comprising the catalyst,
stirring the resulting mixture until the catalyst precipitates on the carbonated structuring material,
said catalyst and said structuring material being insoluble in the mixture of the first and second solvents, wherein the composition comprises catalyst particles distributed on the carbonated structuring material.

33. The composition as claimed in claim 32, comprising at least 80% of the catalyst initially introduced into the mixture.

34. The composition as claimed claim 32, having a catalyst surface density of at least 0.1 μg/cm².

35. The composition as claimed in claim 32, wherein it has electrochemical activity.

36. An electrode, in particular of a fuel cell, comprising a carbonated structuring material combined with a catalyst, saif composition being obtained by implementation of a method comprising the steps of:
preparing a mixture of a solution of a first solvent comprising a carbonated structuring material and a solution of a second solvent comprising the catalyst,
stirring the resulting mixture until the catalyst precipitates on the carbonated structuring material,
said catalyst and said structuring material being insoluble in the mixture of the first and second solvents, wherein the composition comprises catalyst particles distributed on the carbonated structuring material.
